(19) United States
(12) Patent Application Publication
(10) Pub. No.: US 2012/0002199 A1
(43) Pub. Date: Jan. 5, 2012

(54) Means and Methods for Rapid Droplet, Aerosols and Swab Infection Analysis

(75) Inventors: Moshe Ben-David, Tel Aviv (IL); Tomer Eruv, Moreshet (IL); Gallya Gannot, Ramat Hasharon (IL)

(73) Assignee: OPTICUL DIAGNOSTICS LTD., Tel Aviv (IL)

(21) Appl. No.: 13/143,335

(22) PCT Filed: Jan. 5, 2010
(86) PCT No.: PCT/IL10/00008

§ 371 Date: Sep. 22, 2011

(30) Foreign Application Priority Data
Jan. 5, 2009 (IL) 196353

(51) Int. Cl. G01J 3/28; G01N 21/01

(52) U.S. Cl. 356/326; 356/244

(57) ABSTRACT

The present invention provides an optical unit (320) adapted to accommodate a sample and to enable optical detection of infection within said sample; said optical unit comprising a body (100); said body is characterized by a distal end and a proximal end interconnected via a main longitudinal axis; said body (100) comprising at least one mirror (50) coupled to said distal end; wherein said mirror (50) having a proximal and distal surfaces; said proximal surface faces said mask; said proximal surface is adapted to accommodate said sample.

### FIELD OF THE INVENTION

The present invention relates to the field of rapidly identifying bacteria within a sample, especially analyzing droplet, aerosol and swab infection. More particularly, the present invention provides a means for rapidly identifying bacteria by applying spectroscopic measurements on an optical unit.

### BACKGROUND OF THE INVENTION

Droplet infection is an infection transmitted from one individual to another by droplets of moisture expelled from the upper respiratory tract through sneezing or coughing. It is the major transmission route of many bacteria, as well as viruses, and is the culprit of numerous simple and dangerous diseases. Because this route of transmission doesn't even require a close proximity of two individuals, it renders the pathogens highly contagious, and is one of the main causes of endemics and even pandemics.

Some of the bacterial infections carried by droplet contact include streptococcal pharingitis, bacterial meningitis and tuberculosis.

Streptococcal pharingitis is caused by Group A Streptococcus. Apart from the symptoms accompanying a sore throat, this bacterium is dangerous because of the immune response it promotes in certain individuals, which can lead to debilitating or even life-threatening damage to the kidneys, the heart valves and the joints. However, because a sore throat can be also cased by viral pathogens, it is vital to determine whether the infection is bacterial, in which case a course of antibiotics is promptly administered. Therefore, it will be beneficial for the doctor and the patient alike to get an immidiate response for the throat sample.

A rapid strep test exists, in which a throat swab is inserted into a reagent and the presence of the bacteria is determined according to the chemical reaction between the bacteria and the reagent. Results are generally available in 10 or 15 minutes. However, false negative rates are high due to low sensitivity. The test relies on the presence of a carbohydrate antigen unique to Group A Streptococcus, and does not detect the bacterium itself.

Bacterial meningitis is an inflammation of the membranes covering the brain and spinal cord. It is a medical emergency which requires immediate antibiotic treatment due to high mortality and morbidity rates. Most of the pathogens in adults, such as Strep pneumoniae, Neisseria meningitidis and Haemophilus influenzae type b, are transmitted via droplet contact, and thus obliges antibiotic treatment for all persons who were close to the patient. Current diagnosis is made by a lumbar puncture (acquiring the fluid that surrounds the spinal cord), which is a painful procedure with possible risk, performed by trained doctors in medical facilities.

Tuberculosis is an infection caused primarily by Mycobacterium tuberculosis, and is also transmitted via droplet aerosols. Although a longer exposure is usually required for transmission, tuberculosis can be a difficult disease to diagnose, mainly due to the difficulty in culturing this bacterium. The diagnosis is usually based on several tests, most of them harboring high false negative and false positive rates. A fast, reliable test detecting the bacterium itself does not exist commercially. Although the disease is not as lethal as meningitis, it has a very high prevalence and incidence in developed countries and in the growing population of immunosuppressed patients (patients with damaged immune system, such as post cancer treatment and HIV patients).

Thus there is a need for a device for collecting droplet material and of a rapid detection of pathogens in said material.

US patent application no. 2007/0199567 to Kanzer discloses a mask, wherein part of the mask (the inner surface or an exhaust valve) contains a strip for the collection of pathogens. The strip is than sent for PCR analysis in a specialized laboratory, and is thus time consuming and requires dedicated infrastructure.

Other prior art devices in a mask form address the issue of respiratory analysis, such as respiratory function, lung volumes, and the composition of gases in expired breath. For example, U.S. Pat. No. 5,317,156 to Cooper discloses an RF modulation spectroscopy of a near infrared laser diode source, used to determine the amount of a target gas in a breath sample. In the optical cell used, the light beams travel through the lumen of the cell, and the sampled gas fills the lumen. The device cannot detect droplets, which reside on the cell walls and not in the space within, and is not intended to detect the spectrum of a whole bacterium.

Some spectroscopic techniques are already known in the art. For example, PCT No. WO 98/41842 to NELSON, Wilfred discloses a system for the detection of bacteria antibody complexes. The sample to be tested for the presence of bacteria is placed in a medium which contains antibodies attached to a surface for binding to specific bacteria to form an antigen-antibody complex. The medium is contacted with an incident beam of light energy. Some of the energy is emitted from the medium as a lower resonance enhanced Raman backscattered energy. The detection of the presence or absence of the microorganism is based on the characteristic spectral peak of said microorganism. In other words PCT No. WO 98/41842 uses UV resonance Raman spectroscopy.

U.S. Pat. No. 6,599,715 to Laura A. Vanderberg relates to a process for detecting the presence of viable bacterial spores in a sample and to a spore detection system. The process includes placing a sample in a germination medium for a period of time sufficient for commitment of any present viable bacterial spores to occur. Then the sample is mixed with a solution of a lanthanide capable of forming a fluorescent complex with dipicolinic acid. Lastly, the sample is measured for the presence of dipicolinic acid.

U.S. Pat. No. 4,847,198 to Wilfred H. Nelson; discloses a method for the identification of a bacterium. Firstly, taxonomic markers are excited in a bacterium with a beam of ultra violet energy. Then, the resonance enhance Raman back scattered energy is collected substantially in the absence of fluorescence. Next, the resonance enhanced Raman back scattered energy is converted into spectra which corresponds to the taxonomic markers in said bacterium. Finally, the spectra are displayed and thus the bacterium may be identified.

U.S. Pat. No. 6,379,920 to Mostafa A. El-Sayed discloses a method to analyze and diagnose specific bacteria in a biologic sample by using spectroscopic means. The method includes obtaining the spectra of a biologic sample of a non-infected patient for use as a reference, subtracting the reference from the spectra of an infected sample, and comparing the fingerprint regions of the resulting differential spectrum with reference spectra of bacteria. Using this diagnostic technique, U.S. Pat. No. 6,379,920 claims to identify specific bacteria without culturing.

Naumann et al had demonstrated bacteria detection and classification in dried samples using FTIR spectroscopy [Naumann D. et al., “Infrared spectroscopy in microbiology”, Encyclopedia of Analytical Chemistry, R. A. Meyers (Ed.) pp. 102-131, John Wiley & Sons Ltd, Chichester, 2000.]. Marshall et al had identifies live microbes using FTIR Raman spectroscopy [Marshall et al “Vibrational spectroscopy of extant and fossil microbes: Relevance for the astrobiological exploration of Mars”, Vibrational Spectroscopy 41 (2006) 182-189]. Others methods involve fluorescence spectroscopy of a combination of the above.

None of the prior art literature discloses a device and method that are simple, compact and are not expensive. Furthermore, none of the prior art discloses a quick (without culturing) and accurate method that detects bacteria from a sample. The accurate detection is enabled due to the increase of the optical path length and the decrease in the attenuation.

The optical signature of the whole bacteria (as opposed to different proteins of the bacteria) is a superior method for detecting bacteria; as the spectral signature is specific for the bacteria itself, and cross talk between different bacteria strains, that share the same type of protein and thus give a false positive result, is avoided.

Thus, there is still a long felt need for a device that can collect and analyze infected samples such as aerosols produced by coughing or sneezing (or by throat swab, samples take from the nose, wounds or any body liquids that can be applied or spread on the optical unit), which produces fast results, without the use of reagents and/or complicated sample preparation, can differentiate between strains of bacteria, can be operated by untrained personnel, non invasive, with high sensitivity and specificity.

### SUMMARY OF THE INVENTION

It is one object of the present invention to provide an optical unit (320) adapted to accommodate a sample and to enable optical detection of infection within said sample; said optical unit comprising a body (100); said body is characterized by a distal end and a proximal end interconnected via a main longitudinal axis; said body (100) comprising at least one mirror (50) coupled to said distal end; wherein said mirror (50) having a proximal and distal surfaces; said proximal surface faces said mask; said proximal surface is adapted to accommodate said sample.

It is another object of the present invention to provide an optical unit (320) adapted to accommodate a sample and to enable optical detection of infection within said sample; said optical unit comprising a body (100); wherein the internal surface of said body is highly reflected and has mirror-like optical properties; further wherein internal surface is adapted to accommodate said sample.

It is another object of the present invention to provide the optical unit (320) as defined above, wherein said internal surface of said body comprising at least one mirror (50).

It is another object of the present invention to provide an optical unit (320) adapted to accommodate a sample and to enable optical detection of infection within said sample; wherein said optical unit is a mirror upon which said sample is placed.

It is another object of the present invention to provide the optical unit (320) as defined above, wherein said proximal surface is a mirror.

It is another object of the present invention to provide the optical unit (320) as defined above, wherein said proximal surface has a surface chosen from a group comprising of planar surface, concave, surface, convex surface, hyperbolic, parabolic, conal shape.

It is another object of the present invention to provide the optical unit (320) as defined above, wherein the surface of said mirror is selected from a group comprising of planar surface, concave, surface, convex surface, hyperbolic, parabolic, conal shape.

It is another object of the present invention to provide the optical unit (320) as defined above, additionally comprising a double sided mirror disposed along said main longitudinal axis.

It is another object of the present invention to provide the optical unit (320) as defined above, wherein said body is an elongated tube (10) has an internal lumen; said elongated tube (10) is adapted to accommodate said sample.

It is another object of the present invention to provide the optical unit (320) as defined above, wherein internal surface of said body is highly reflected and has mirror-like optical properties.

It is another object of the present invention to provide the optical unit (320) as defined above, wherein said body comprising at least one optical window (50), adapted to allow light beams to enter said body (100) such that said optical detection of said bacteria is enabled.

It is another object of the present invention to provide the optical unit (320) as defined above, wherein said body comprising at least one mask at least partially reversibly coupled to said proximal end of said body (100), adapted to enable collection of said sample.

It is another object of the present invention to provide the optical unit (320) as defined above, wherein said sample is a sample selected from an aerosol sample, a droplet sample or a swab sample.

It is another object of the present invention to provide the optical unit (320) as defined above, wherein said optical window (50) is adapted to seal said elongated tube (100) such that contamination of said sample is minimized.

It is another object of the present invention to provide the optical unit (320) as defined above, wherein said body (100) additionally comprises at least one check valve (30) at least partially coupled to said distal end of said body (100); adapted to decompress large air volumes entering said elongated tube.

It is another object of the present invention to provide the optical unit (320) as defined above, said mask is selected from a group consisting of a mouthpiece and a nose-mouth mask.

It is another object of the present invention to provide the optical unit (320) as defined above, wherein said infection contains bacteria selected from a group consisting of Gram negative pathogens such as Various types of Acinetobacter, A. baumannii, Stenotrophomonas maltophilia, Gram positive pathogens such as Streptococcus pneumonia resistant to β lactamase and macrolides, Streptococcus viridian group resistant to β lactamase and aminoglycosides, enterococci resistant to vancomycin and teicoplanin and highly resistant to penicillins and aminoglycosides, Enterococcus Faecium, Enterococcus Faecalis, staphylococcus aureus SENSITIVE AND resistant to methicillin, other B lactams, macrolides, lincosamides and aminoglicozides. Streptococcus pyogenes resistant to macrolides, macrolide-resistant streptococci of groups B, C and G. Coagulase negative staphylococci resistant to β lactams, aminoglycosides, macrolides, lincosamides and glycopeptides, multiresistant strains of Listeria and corynebacterium, Peptostreptococcus and clostridium, C. Difficile, resistant to penicillins and macrolides, Haemophilus Influenza resistant to β lactamase, Pseudomonas Aeruginosa, Stenotrophomonas Maltophilia, Klebsiella Pneumonia resistant to antibiotics Klebsiella Pneumonia Resistant to carbapenem, Klebsiella Pneumonia sensitive to antibiotics, aminoglycosides and macrolides or any combination thereof.

It is another object of the present invention to provide the optical unit (320) as defined above, wherein said detection is made by detecting the absorption spectrum specific for said bacteria.

It is another object of the present invention to provide the optical unit (320) as defined above, wherein said body is adapted to enhance the interaction between light and said sample within said tube.

It is another object of the present invention to provide the optical unit (320) as defined above, wherein said body is especially adapted to minimize the attenuation due to reflection from said elongated tube walls and blind spots.

It is another object of the present invention to provide the optical unit (320) as defined above, wherein the internal walls of said body are coated with at least one reflecting coating layer.

It is another object of the present invention to provide the optical unit (320) as defined above, wherein said internal walls of said elongated tube are coated with at least one metal layer selected from a group consisting of Au, Ag, Al, Cu etc. or any combination thereof.

It is another object of the present invention to provide the optical unit (320) as defined above, wherein said internal walls of said body are coated with at least one dielectric layer selected from a group consisting of AgI, CdS, CdSe etc. or any combination thereof.

It is another object of the present invention to provide the optical unit (320) as defined above, wherein said internal walls of said body are coated with at least one metal layer and one dielectric layer.

It is another object of the present invention to provide the optical unit (320) as defined above, wherein said optical window and/or said mirror can be made from materials selected from a group consisting of gold, silver, aluminum (for the mirror) or Polyethylene, PTFE, propylene, polydiene, polyamides, polystyrene and copolymers thereof, polyethylene, ethylene-octene copolymer, polyvinylpyrrolidene, poly(acenaphthylene), styrene/ethylene-butylene copolymer, poly(1-butene), polymers of the ammonium salt of acrylic acid, ethylene/propylene copolymer and ethylene/propylene/diene terpolymer, which are transparent at the required wavelength and neoprene, polyurethane, fluorelastomer, polycarbonate, polyether sulfone, polyether ether-ketone, and polyacrylate and/or glass, or a crystal that are transparent in the required wavelength range.

It is another object of the present invention to provide the optical unit (320) as defined above, additionally comprising sealing means coupled to said body adapted to minimize contamination of said sample.

It is another object of the present invention to provide the optical unit (320) as defined above, wherein said body additionally comprises an indicator for quantifying said sample.

It is another object of the present invention to provide the optical unit (320) as defined above, wherein said body is single use and disposable.

It is another object of the present invention to provide the optical unit (320) as defined above, additionally comprising an RF ID chip utilizing a code such that once said code was read no additional use of said optical unit is enabled.

It is another object of the present invention to provide the optical unit (320) as defined above, additionally comprising at least one firing-pin adapted to ensure a single use of said optical unit.

It is another object of the present invention to provide the optical unit (320) as defined above, wherein said sample is collected from a group consisting of swab, fluid by a capillary tube, humans or animals or non medical material.

It is another object of the present invention to provide the optical unit (320) as defined above, wherein said body increases the OPL and decreases the attenuation such that (i) an enhanced light interaction with said sample accommodated within said optical unit is obtained; (ii) the EIL ratio obtained is about 100%; (iii) the minimum no. of bacteria needed for said detection in said optical unit is lower than 0.5 times lower than the minimum No. of bacteria needed for said detection in a standard (conventional) optical unit; the minimum amount C of said bacteria within said sample needed for said detection is lower than 5×10⁵ bacteria.

It is another object of the present invention to provide the optical unit (320) as defined above, wherein said detection of said infection is determined from said spectroscopic data in the region of about 3000-3300 cm⁻¹ and/or about 850-1000 cm⁻¹ and/or about 1300-1350 cm⁻¹, and/or about 2836-2995 cm⁻¹, and/or about 1720-1780 cm⁻¹, and/or about 1550-1650 cm⁻¹, and/or about 1235-1363 cm⁻¹, and/or about 990-1190 cm⁻¹ and/or about 1500-1800 cm⁻¹ and/or about 2800-3050 cm⁻¹ and/or about 1180-1290 cm⁻¹.

It is another object of the present invention to provide the optical unit (320) as defined above, additionally comprising an absorbing element either dispensed within said optical unit; or coating at least a portion of the internal surface of said optical unit (320), adapted to ensure the originality of said optical unit (320).

It is another object of the present invention to provide an optical detection system for identifying an infection within a droplet sample, comprising:
a. at least one optical unit (320) adapted to accommodate said sample; said optical unit comprising a body (100); said body is characterized by a distal end and a proximal end interconnected via a main longitudinal axis; wherein said body (100) comprising at least one mirror (50) coupled to said distal end:
b. at least one light source (310) adapted to emit light into said optical unit;
c. detecting means, especially spectrometer, (350) adapted to receive the spectroscopic data of said sample by collecting the light exiting from said optical unit; and,
a. processing means (450) in communication with said detecting means, adapted to (i) analyze said spectroscopic data and to (ii) detect the presence of said bacteria within said sample.

It is another object of the present invention to provide an optical detection system for identifying an infection within a droplet sample, comprising:
a. at least one optical unit (320) adapted to accommodate said sample; said optical unit comprising a body (100); wherein said optical unit comprising a body (100); wherein the internal surface of said body comprises a mirror; further wherein internal surface is adapted to accommodate said sample;
b. at least one light source (310) adapted to emit light into said optical unit;
c. detecting means, especially spectrometer, (350) adapted to receive the spectroscopic data of said sample by collecting the light exiting from said optical unit; and,
d. processing means (450) in communication with said detecting means, adapted to (i) analyze said spectroscopic data and to (ii) detect the presence of said bacteria within said sample.

It is another object of the present invention to provide the optical detection system as defined above, wherein said mirror (50) having a proximal and distal surfaces; said proximal surface is adapted to accommodate said sample.

It is another object of the present invention to provide the optical detection system as defined above, wherein said proximal surface has a surface chosen from a group comprising of planar surface, concave, surface, convex surface, hyperbolic, parabolic, conal shape.

It is another object of the present invention to provide an optical detection system for identifying an infection within a droplet sample, comprising:
a. at least one optical unit (320) adapted to accommodate said sample; said optical unit comprising a body (100); wherein said optical unit is a mirror upon which said sample is placed;
b. at least one light source (310) adapted to emit light into said optical unit;
c. detecting means, especially spectrometer, (350) adapted to receive the spectroscopic data of said sample by collecting the light exiting from said optical unit; and,
d. processing means (450) in communication with said detecting means, adapted to (i) analyze said spectroscopic data and to (ii) detect the presence of said bacteria within said sample.

It is another object of the present invention to provide the optical detection system as defined above, wherein the surface of said mirror is selected from a group comprising of planar surface, concave, surface, convex surface, hyperbolic, parabolic, conal shape.

It is another object of the present invention to provide the optical detection system as defined above, additionally comprising a parabolic mirror in optical communication with said optical unit; and a plurality of adjustable mirror in optical communication with said parabolic mirror such that said parabolic mirror and said plurality of adjustable mirror increase the OPL.

It is another object of the present invention to provide the optical detection system as defined above, wherein said body is an elongated tube (10) has an internal lumen; said elongated tube (10) is adapted to accommodate said sample.

It is another object of the present invention to provide the optical detection system as defined above, wherein internal surface of said body is highly reflected and has mirror-like optical properties.

It is another object of the present invention to provide the optical detection system as defined above, wherein said optical unit additionally comprising a double sided mirror disposed along said main longitudinal axis.

It is another object of the present invention to provide the optical detection system as defined above, wherein said body comprising at least one optical window (50) in mechanical communication with said body (100), adapted to allow light beams to enter said body (100) such that said optical detection of said bacteria is enabled.

It is another object of the present invention to provide the optical detection system as defined above, wherein said body comprising at least one mask at least partially reversibly coupled to said proximal end of said body (100), adapted to enable collection of said sample.

It is another object of the present invention to provide the optical detection system as defined above, wherein said sample is a sample selected from an aerosol sample, a droplet sample or a swab sample.

It is another object of the present invention to provide the optical detection system as defined above, wherein said body (100) additionally comprises at least one check valve (30) at least partially coupled to said distal end of said body (100); adapted to decompress large air volumes entering said elongated tube.

It is another object of the present invention to provide the optical detection system as defined above, wherein said optical detection system additionally comprises at least one entrance beam shaping means adapted to shape a light source beam such that the optical light path length is maximized within said body.

It is another object of the present invention to provide the optical detection system as defined above, wherein said optical detection system additionally comprises at least one exit beam shaping means adapted to collect light that is coming out of said body and guiding it to a detector.

It is another object of the present invention to provide the optical detection system as defined above, wherein said entrance and exit beam shaping means is optimized by means of simulation such that light distribution inside said optical unit is maximized.

It is another object of the present invention to provide the optical detection system as defined above, wherein said entrance or exit beams shaping means is selected from a group consisting of lenses and prisms, mirrors, OEM optical element, axicon or any combination thereof.

It is another object of the present invention to provide the optical detection system as defined above, wherein said infection contains bacteria selected from a group consisting of Gram negative pathogens such as Various types of Acinetobacter, A. baumannii, Stenotrophomonas maltophilia, Gram positive pathogens such as Streptococcus pneumonia resistant to β lactamase and macrolides, Streptococcus viridians group resistant to β lactamase and aminoglycosides, enterococci resistant to vancomycin and teicoplanin and highly resistant to penicillins and aminoglycosides, Enterococcus Faecium, Enterococcus Faecalis, staphylococcus aureus SENSITIVE AND resistant to methicillin, other B lactams, macrolides, lincosamides and aminoglicozides. Streptococcus pyogenes resistant to macrolides, macrolide-resistant streptococci of groups B, C and G. Coagulase negative staphylococci resistant to β lactams, aminoglycosides, macrolides, lincosamides and glycopeptides, multiresistant strains of Listeria and corynebacterium, Peptostreptococcus and clostridium, C. Difficile, resistant to penicillins and macrolides, Haemophilus Influenza resistant to β lactamase, Pseudomonas Aeruginosa, Stenotrophomonas Maltophilia, Klebsiella Pneumonia resistant to antibiotics Klebsiella Pneumonia Resistant to carbapenem, Klebsiella Pneumonia sensitive to antibiotics, aminoglycosides and macrolides or any combination thereof.

It is another object of the present invention to provide the optical detection system as defined above, wherein said detection is made by detecting the absorption spectrum specific for said bacteria.

It is another object of the present invention to provide the optical detection system as defined above, wherein said body is adapted to enhance the interaction between light and said sample within said body.

It is another object of the present invention to provide the optical detection system as defined above, wherein said body is especially adapted to minimize the attenuation due to reflection from said body walls and blind spots.

It is another object of the present invention to provide the optical detection system as defined above, wherein the internal walls of said body are coated with at least one coating layer.

It is another object of the present invention to provide the optical detection system as defined above, wherein the internal walls of said body are coated with at least one metal layer selected from a group consisting of Au, Ag, Al, Cu etc. or any combination thereof.

It is another object of the present invention to provide the optical detection system as defined above, wherein said internal walls of said body are coated with at least one dielectric layer selected from a group consisting of AgI, CdS, CdSe etc. or any combination thereof.

It is another object of the present invention to provide the optical detection system as defined above, wherein said internal walls of said body are coated with at least one metal layer and one dielectric layer.

It is another object of the present invention to provide the optical detection system as defined above, wherein said mirror or said optical window can be made from materials selected from a group consisting of gold, silver, aluminum, Polyethylene, PTFE, propylene, polydiene, polyamides, polystyrene and copolymers thereof, polyethylene, ethyl ene-octene copolymer, polyvinylpyrrolidene, poly(acenaphthylene), styrene/ethylene-butylene copolymer, poly(1-butene), polymers of the ammonium salt of acrylic acid, ethylene/propylene copolymer and ethylene/propylene/diene terpolymer, which are transparent at the required wavelength and neoprene, polyurethane, fluorelastomer, polycarbonate, polyether sulfone, polyether ether-ketone, and polyacrylate and/or glass, or a crystal that are transparent in the required wavelength range.

It is another object of the present invention to provide the optical detection system as defined above, additionally comprising sealing means coupled to said body, and adapted to minimize contamination of said sample.

It is another object of the present invention to provide the optical detection system as defined above, wherein said sealing means comprises a filter.

It is another object of the present invention to provide the optical detection system as defined above, wherein said body additionally comprises an indicator for quantifying said sample.

It is another object of the present invention to provide the optical detection system as defined above, wherein said body is single use and disposable.

It is another object of the present invention to provide the optical detection system as defined above, additionally comprising an RF ID chip utilizing a code such that once said code was read no additional use of said optical unit is enabled.

It is another object of the present invention to provide the optical detection system as defined above, additionally comprising at least one firing-pin adapted to ensure a single use of said optical unit.

It is another object of the present invention to provide the optical detection system as defined above, wherein said sample is collected from a group consisting of swab, fluid by a capillary tube, humans or animals or non medical material.

It is another object of the present invention to provide the optical detection system as defined above, wherein said body increases the OPL and decreases the attenuation such that (i) an enhanced light interaction with said sample accommodated within said optical unit is obtained; (ii) the EIL ratio obtained is about 100%; (iii) the minimum no. of bacteria needed for said detection in said optical unit is lower than 0.5 times lower than the minimum No. of bacteria needed for said detection in a standard (conventional) optical unit; the minimum amount C of said bacteria within said sample needed for said detection is lower than 5×10⁵ bacteria.

It is another object of the present invention to provide the optical detection system as defined above, wherein said detection of said infection is determined from said spectroscopic data in the region of about 3000-3300 cm⁻¹ and/or about 850-1000 cm⁻¹ and/or about 1300-1350 cm⁻¹, and/or about 2836-2995 cm⁻¹, and/or about 1720-1780 cm⁻¹, and/or about 1550-1650 cm⁻¹, and/or about 1235-1363 cm⁻¹, and/or about 990-1190 cm⁻¹ and/or about 1500-1800 cm⁻¹ and/or about 2800-3050 cm⁻¹ and/or about 1180-1290 cm⁻¹.

It is another object of the present invention to provide the optical detection system as defined above, wherein said optical detection system additionally comprises at least one mirror, adapted to reflect a light source beam such that a maximal area of said proximal surface is hit by said light, for at least one time.

It is another object of the present invention to provide the optical detection system as defined above, wherein said optical detection system additionally comprises at least one lens, adapted to refract a light source beam such that a maximal area of said proximal surface is hit by said light, for at least one time.

It is another object of the present invention to provide the optical detection system as defined above, wherein said light source (310) is adapted to emit un-collimated light into said optical unit.

It is another object of the present invention to provide the optical detection system as defined above, wherein said un-collimated light has an angle of diverse of at least 25 milli-radians.

It is another object of the present invention to provide a method for optically detecting or identifying an infection within a droplet sample. The method comprising steps selected inter alia from:
a. obtaining at least one optical unit (320) adapted to accommodate said droplet infection; said optical unit comprising a body (100); said body is characterized by a distal end and a proximal end interconnected via a main longitudinal axis; wherein said body (100) comprising at least one mirror (50) coupled to said distal end:
b. accommodating within said optical unit said sample;
c. coupling at least one light source (310) to said optical unit;
d. coupling detecting means, especially spectrometer, (350) to said optical unit;
e. providing processing means (450) in communication with said detecting means, adapted to (i) analyze said spectroscopic data and to (ii) detect the presence of said bacteria within said sample;
f. emitting light from said light source (310) into said optical unit (320);
g. collecting the light exiting from said optical unit by said detecting means;
h. detecting and processing said light emitted from said optical unit (320) by said detecting means and said processing means; and,
i. identifying said infection.

It is another object of the present invention to provide a method for optically detecting or identifying an infection within a droplet sample. The method comprising steps selected inter alia from:
a. obtaining at least one optical unit (320) adapted to accommodate said droplet infection; said optical unit comprising a body (100); wherein the internal surface of said body is highly reflected and has mirror-like optical properties; further wherein internal surface is adapted to accommodate said sample:
b. accommodating within said optical unit said sample;
c. coupling at least one light source (310) to said optical unit;
d. coupling detecting means, especially spectrometer, (350) to said optical unit;
e. providing processing means (450) in communication with said detecting means, adapted to (i) analyze said spectroscopic data and to (ii) detect the presence of said bacteria within said sample;
f. emitting light from said light source (310) into said optical unit (320);
g. collecting the light exiting from said optical unit by said detecting means;
h. detecting and processing said light emitted from said optical unit (320) by said detecting means and said processing means; and,
i. identifying said infection.

It is still an object of the present invention to provide a method for optically detecting or identifying an infection within a droplet sample. The method comprising steps selected from:
a. obtaining at least one optical unit (320) adapted to accommodate said droplet infection; said optical unit comprising a body (100); wherein said optical unit is a mirror upon which said sample is placed;
b. accommodating upon said optical unit said sample;
c. coupling at least one light source (310) to said optical unit;
d. coupling detecting means, especially spectrometer, (350) to said optical unit;
e. providing processing means (450) in communication with said detecting means, adapted to (1) analyze said spectroscopic data and to (ii) detect the presence of said bacteria within said sample;
f. emitting light from said light source (310) into said optical unit (320);
g. collecting the light exiting from said optical unit by said detecting means;
h. detecting and processing said light emitted from said optical unit (320) by said detecting means and said processing means; and,
i. identifying said infection.

It is lastly an object of the present invention to provide the method as defined above, wherein said step of accommodating upon said optical unit said sample is performed by smearing said sample upon said mirror.

### BRIEF DESCRIPTION OF THE FIGURES

In order to understand the invention and to see how it may be implemented in practice, a plurality of embodiments will now be described, by way of non-limiting example only, with reference to the accompanying drawings, in which

FIG. 1 schematically illustrates the core concept behind spectrometric measurement.

FIGS. 2A, 2B and 2C schematically illustrate conventional and commonly used optical cells for spectroscopic measurements.

FIG. 3 represents the general build of the optical cell.

FIG. 4-7 represents embodiments of the sample collecting device.

FIG. 8 shows embodiments of the check valve.

FIG. 9 represents indicators for sample quantity.

FIG. 10 shows embodiments of a folding elongated tube.

FIG. 11 schematically illustrates the cross section of the optical cell

FIGS. 12A, 12B illustrates the OPL whilst using the optical cell according to the present invention.

FIGS. 13 illustrates the exit and/or entrance beam shaping means.

FIG. 14 illustrates an optimization of OPL using beam shaping means, in this case axicons.

FIG. 15 illustrates the systems sensitivity for detecting varied concentrations of bacteria.

FIG. 16 shows a spectrometric measurement setup.

FIG. 17 illustrates in a block diagram an optical detection device according to the present invention.

FIG. 18 illustrates n light sources incorporated within an optical detection device.

FIG. 19 illustrates a nose-mouth mask with containers.

FIG. 20 illustrates an example of the propagation of a light beam within an optical cell.

FIG. 21 discloses a possible method of optical cell coating.

FIG. 22 illustrates the differentiation between samples of blood with MRSA and MSSA.

FIG. 23 illustrates the differentiation between nose swabs samples spiked with MRSA and MSSA.

FIG. 24 illustrates the differentiation between axillary swabs spiked with MRSA and MSSA.

FIG. 25 illustrates a scatter plot of the cough clinical study performed.

### DETAILED DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a device and method for easily collecting and detecting bacteria within a sample by using Spectroscopic measurements. The detection is facilitated by increasing the optical path length and/or decreasing the attenuation of light from an optical cell accommodating the sample.

The term “optical unit” refers hereinafter to a unit possessing optical features, specifically a unit chosen from a group comprising an optical window, an optical mirror and an optical cell.

The term “mask” refers hereinafter to any mask including a nose-mouth mask or a mouth mask.

The term “optical window” refers hereinafter to any of transparent optical material that enables the entrance of light in a desired wavelength into an optical instrument. According to some embodiments instead of an optical window, a mirror is used. The benefits of using a mirror are, among others, to enable second/third/fourth et cetera interactions between the light and the sample within the optical instrument.

The term “sample” refers herein to either an aerosol sample, or a liquid sample or a solid sample. The present invention provides a detection device that can detect bacteria in liquids and swabs as well as in aerosol. The detection device can be used for medical or non-medical applications. The detection device can be used for example in detecting bacteria in water, beverages, food production, sensing for hazardous materials in crowded places etc.

The term “enhanced light interaction” (ELI) refers hereinafter to an intensified or an increase in the interaction between light and the sample.

The term “about” refers hereinafter to a range of 25% below or above the referred value.

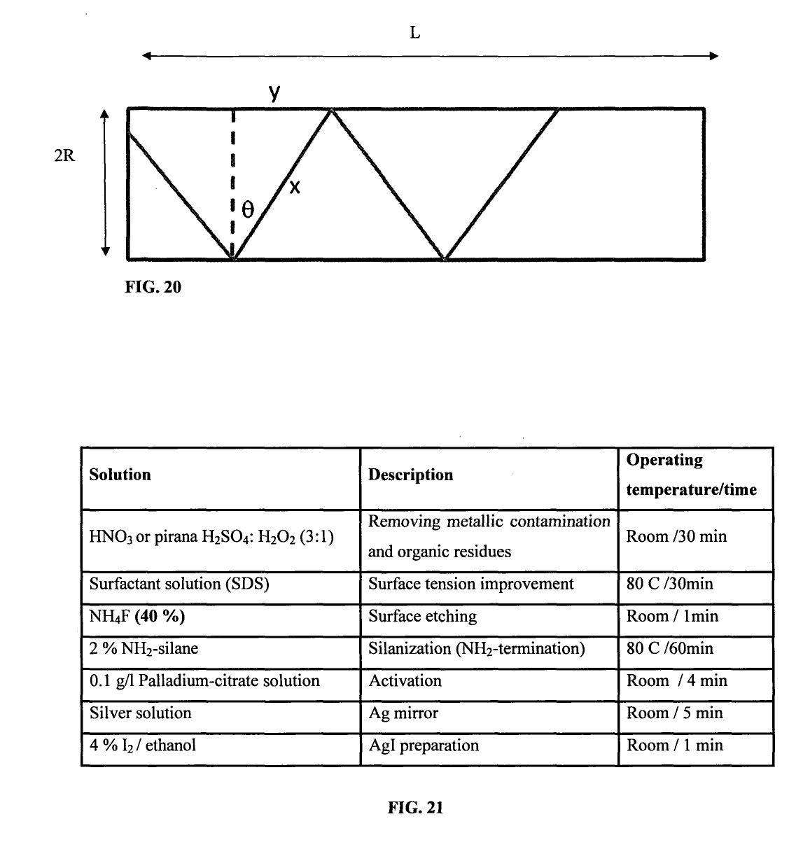

The term “Optical Path Length (OPL)” refers hereinafter to the geometric length of the path the light follows through the system. A difference in optical path length between two paths is often called the optical path difference (OPD). The exact OPL calculation is given in example 1 (FIG. 20).

The term “effective interacted light (EIL)” refers hereinafter to the amount of light that actually interacts with the sample within an optical cell out of the total light emitted from a light source.

One of the main disadvantages of conventional optical cells (such as a ‘white cell’) is the fact that the OPL is increased by using mirrors so as to cause the light to reflect back and forth. Therefore, the EIL highly depends on the cross section area of the cell, the amount of mirrors within the cell, the mirror alignment within the cell, the angle of incidence, the angle at which the light enters the cell. Consequently, no EIL ratio of about 100% can be achieved. Furthermore, since the light does not impact the entire volume of the cell, dead areas or blind spots are created within the cell. It should be emphasized that in the optical cell as described in the present invention, the light coming into the cell impacts on the ‘walls’ of the cell.

Yet another major disadvantage of those kinds of cells is the large dimensions of the cell. In many configurations the OPL is increased by increasing the size of the optical cell. Furthermore these kinds of cells are very expensive.

The term “attenuation” refers hereinafter to the reduction in the amplitude and intensity of a signal.

The term “check valve” refers hereinafter to a mechanical device, a valve, which normally allows fluid (liquid or gas) to flow through it in only one direction.

The term “Droplet infection” refers hereinafter to an infection transmitted from one individual to another by droplets of moisture expelled from the upper respiratory tract through sneezing or coughing.

The term “pandemic” refers hereinafter to an epidemic of infectious disease that spreads through human populations across a large region, for example a continent, or even worldwide.

The term “PCR polymerase chain reaction” is a technique which amplifies a single or few copies of a piece of DNA across several orders of magnitude, generating millions or more copies of the DNA piece.

The present invention provides an optical detection device which is a spectroscopic device adapted to utilize the unique spectroscopic signature of microbes/bacteria/hazardous materials and thus enables the detection of said microbes/bacteria/hazardous materials within a sample accommodated with the cell.

The bacteria to be detected can be selected, but not limited, from a group consisting of is selected from a group consisting of Gram negative pathogens such as Various types of Acinetobacter (for example: A. baumannii), Stenotrophomonas maltophilia, Gram positive pathogens such as Streptococcus pneumonia resistant to β lactamase and macrolides, Streptococcus viridians group resistant to β lactamase and aminoglycosides, enterococci resistant to vancomycin and teicoplanin and highly resistant to penicillins and aminoglycosides (for example: Enterococcus Faecium, Enterococcus Faecalis), staphylococcus aureus SENSITIVE AND resistant to methicillin, other B lactams, macrolides, lincosamides and aminoglicozides. Streptococcus pyogenes resistant to macrolides, macrolide-resistant streptococci of groups B, C and G. Coagulase negative staphylococci resistant to β lactams, aminoglycosides, macrolides, lincosamides and glycopeptides, multiresistant strains of Listeria and corynebacterium, Peptostreptococcus and clostridium (FOR EXAMPLE: C. Difficile), resistant to penicillins and macrolides, Haemophilus Influenza resistant to β lactamase, Pseudomonas Aeruginosa, Stenotrophomonas Maltophilia, Klebsiella Pneumonia resistant to antibiotics (for example: Klebsiella Pneumonia Resistant to carbapenem), Klebsiella Pneumonia sensitive to antibiotics, aminoglycosides and macrolides or any combination thereof.

Spectroscopic measurements, whether absorption, fluorescence, Raman, or scattering, are the bases for all optical sensing devices. In order to identify a hazardous material (for example bacteria) a sample that might contain the material is placed inside a spectrometer and the absorption/scattering/fluorescence or Raman spectrum of the sample is then analyzed to verify whether the spectral signature of the hazardous material is recognized.

Therefore, one of the core objects of the present invention is to provide an optical unit, which will enable maximal exposure of the sample to light, which will consequently be analyzed by a spectrometer.

One embodiment of such an optical unit is an optical reflector, or a configuration of optical reflector and optical components, possessing the following characteristics:
1. Collecting capabilities of sample material;
2. Maximum sensitivity by Maximizing the optical path length (OPL) through the sample;
3. Minimal attenuation of the optical window/mirror;
4. Minimal number of blind spots;
5. Disposable;
6. Inexpensive, Since no expensive optical instruments were in use; and
7. Sterile.

Another embodiment of an optical unit is an optical cell or a configuration of optical cell and optical components possessing the following characteristics:
1. Collecting capabilities of sample material;
2. Maximum sensitivity by Maximizing the optical path length (OPL) through the sample;
3. Simple and compact optical cell, which does not include any additional optical instruments (such as lenses or mirrors);
4. Minimal attenuation due to reflection from the cell walls;
5. Minimal number of blind spots;
6. Disposable;
7. Inexpensive, Since no expensive optical instruments were in use; and
8. Sterile—the use of a nose-mouth mask and of a unidirectional valve prevents contamination.

The present invention therefore provides an optical cell adapted to accommodate a sample for detection or identification of bacteria or other hazardous material within a sample. The detection of low material concentrations is provided via increasing the Optical Path Length (OPL) and decreasing the attenuation (due to reflection from the optical cell wall) by the optical cell itself such that (i) an enhanced light interaction within the sample accommodated within said optical cell is obtained; (ii) the Effective Interacted Light (EIL) ratio obtained is about 100%; and, (iii) the minimum concentration of the bacteria needed for said detection in said optical cell is lower than about 0.5 times lower than the minimum No. of bacteria needed for said detection in a standard (conventional) optical cell; the minimum amount of said bacteria within the sample needed for said detection is lower than 5×10⁵ bacteria; (iv) further wherein the OPL increase is about 6 times greater than the physical length of said optical cell; and said attenuation decrease due to reflection from the optical cell wall is at least 10% lower than similar optical cells.

The present invention also provides an optical detection system adapted to identify bacteria within a sample.

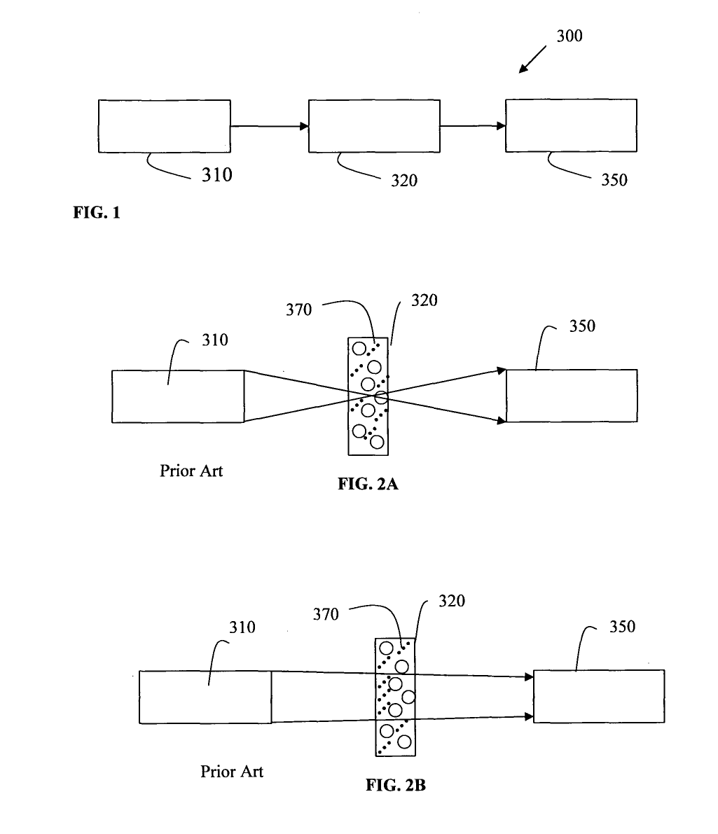

Reference is now made to FIG. 1 illustrating the core concept behind any spectrometric measurement. As can be seen from the figure, a spectrometric measurement setup (300) generally comprises a light source 310, an optical unit 320 and a detector (which is usually a spectrometer) 350. Usually the light source 310 and the detector 350 are combined to form a spectrometer.

The light is emitted from the light source 310 and interacts with the sample within the optical unit 320. The light might be absorbed and/or scattered by the material or excite the sample to a higher energy state and therefore emits light in a different wavelength. The light source could be a laser, LED, monochromator, tunable laser, tunable light source or a lamp, and the spectrometer (350) could be based on filters (filter wheels, tunable filters), grating or Fourier transform spectrometer. Alternatively one can use a tunable light source, tunable laser or monochromator, and a detector.

All of the prior art optical cells related to sampling (cuvettes, gas cells etc.) are designed to hold the sampling material and have no active participation in the measurement itself. One object of the present invention is to disclose an optical cell 320 that is especially adapted to be an active participant within the spectroscopic measurements by enhancing the interaction between the light and sample within said optical cell.

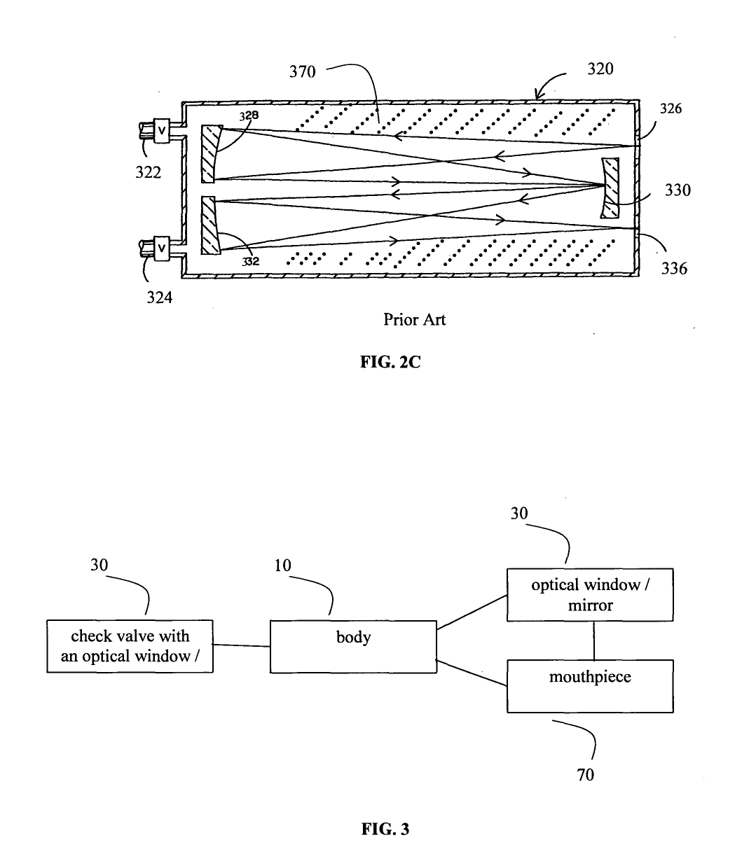

It is acknowledged that in the case of an optical cell, the quality of the interaction between the sample and the light depends on two parameters: the optical path length (OPL) the light travels through the sample within the optical cell 320, and the amount of the sample which is illuminated by the light. In conventional light source sampling cell configuration, the light emitted from the light source 310 is either focused or collimated on the sample within the sampling cell 320 and it usually passes through the sample in a straight line (see FIGS. 2A and 2B respectively). In these cases only a small part of the sample interacts with the light. Therefore, the required signal will be weak and the bacteria (which are present in the sample) may not be identified by the detector 350.

Other cells (such as a ‘white cell’) use mirrors to cause the light to reflect back and forth and hence increase the OPL (see FIG. 2C). However, as can be seen from the FIGS. 2A, 2B and 2C, blind spots ('dead area') are created. Those blind spots are areas within the optical cell in which the light does not pass through. The blind spots are denoted in the figures as numerical reference 370.

We will first disclose the design embodiments of our optical unit, suited for collecting droplet samples, than the optical optimizing means of our optical unit, adapted to increase the efficiency of the analysis, and finally the entire optical detection device.

1. Optical Unit Design as a Droplet Sample Collector

a. Optical Unit Design—Optical Cell

According to a preferred embodiment of the present invention the sample collecting device (100), which is ultimately the optical cell 320, consists of a body (10) the body is characterized by a distal end and a proximal end interconnected via a main longitudinal axis; wherein said body (100) comprising at least one mirror (50) coupled to said distal end.

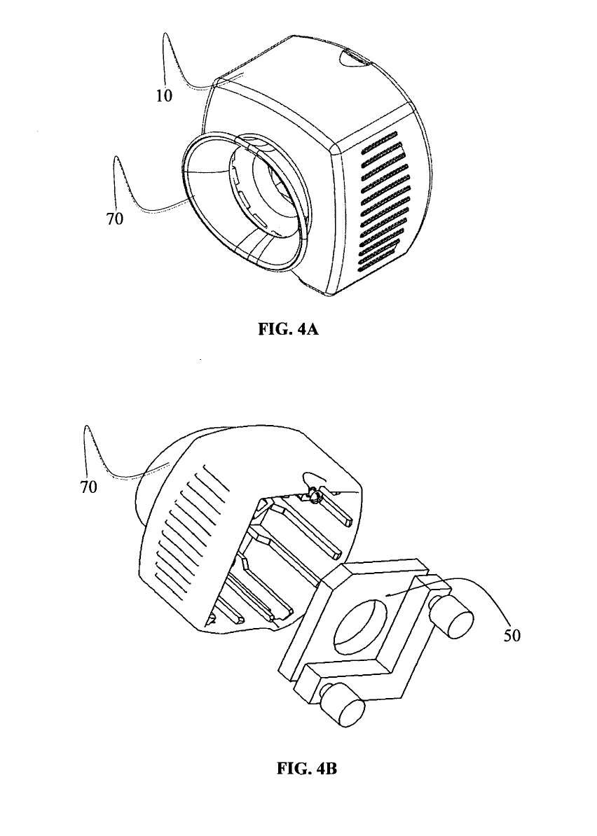

FIG. 3 schematically represents, in a non limiting manner, an alternative general design of the optical unit 320. According to this embodiment, the optical unit 320, used in the spectrometric measurement, is actually the vessel which collects the aerosol. The droplet collecting device (100), which is ultimately the optical cell 320, consists of a body (10), an optical window/mirror (30) at its proximal end (optionally within a mouthpiece (70) which may contain a hatchway (72)); and a second optical window/mirror at its distal end (which may additionally comprise a check valve (30)). As the user coughs into the droplet collecting device (100), the hatchway (72) opens momentarily (or alternatively until the patient finishes to cough) and then closes.

The check valve (30) allows the escape of excess air and seals the elongated tube (10) on its distal end after the pressure drops.

According to one embodiment, the optical window/mirror (50) closes the body (10). These mechanisms prevent contaminating of the body by allowing only the respiratory aerosol to enter. The faster the droplet collecting device (100) is re-sealed, the less contamination occurs. It also ensures that a sterilized environment is kept around the coughing subject.

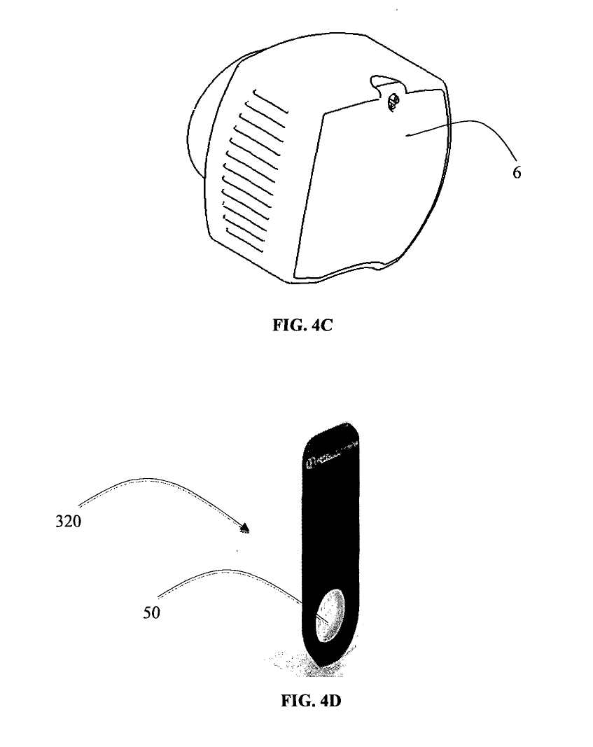

FIGS. 4a-4c illustrates a preferred embodiment of the present invention.

According to the preferred embodiment, the body (10) is characterized by a distal end and a proximal end interconnected via a main longitudinal axis and comprises at least one mirror (50) coupled to the distal end of the body (10).

A mouthpiece (70) is coupled to the proximal end of the body (10). Once the patient coughed into the mask (i.e., after the droplet sample is dispersed directly onto the mirror (50)), the mirror (50) is removed and transferred to system for detection of various bacteria.

It should be emphasized after the patient coughs, the cover 6 is removed, the mirror (50) is drawn and placed in the optical detection system 400.

According to another embodiment, the surface of the optical reflector can be either flat, concave or convex.

According to another embodiment of the present the mirror (50) has a proximal and distal surfaces. The proximal surface faces the mouthpiece (70). According to some other embodiments the proximal surface of the mirror is adapted to accommodate said sample.

According to another embodiment, the proximal surface has a surface chosen from a group comprising of planar surface, concave, surface, convex surface, hyperbolic, parabolic, conal shape.

According to another embodiment, the body is an elongated tube (10) has an internal lumen; said elongated tube (10) is adapted to accommodate said sample.

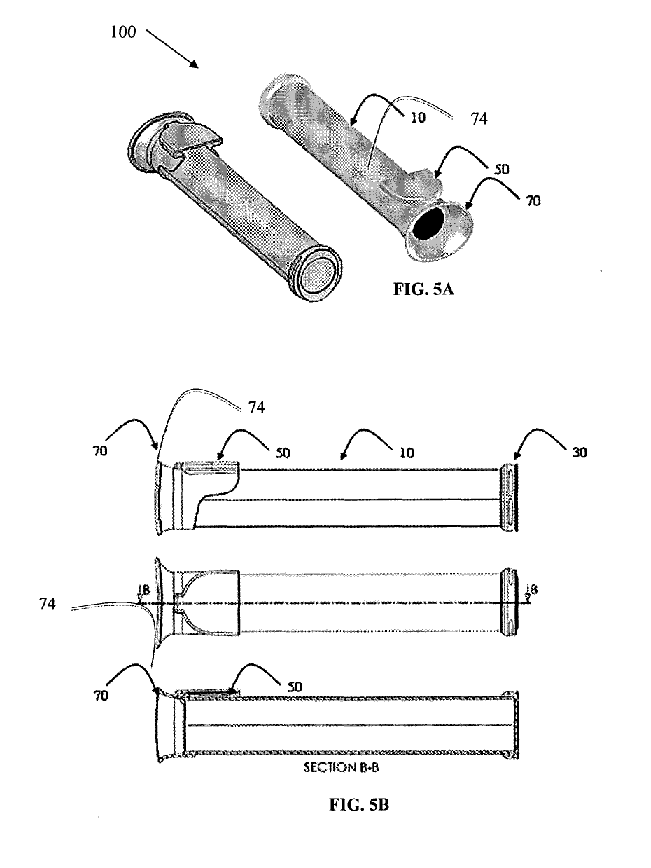

FIGS. 5A-5B schematically represents embodiments of the sample collecting device (100) in which an elongated tube (10) is used.

In these embodiments, the optical window/mirror (50) is coupled to the elongated tube (10) on a hinge and a spring. In the initial position the spring is extended and held in place by a retaining member or the mouthpiece (70) itself. After coughing the retaining member is pulled away, releasing the optical window/mirror (50) to turn and close the elongated tube (10).

Reference is now made to FIG. 4D which illustrates another embodiment of the present invention. According to the embodiment an optical unit (320) adapted to accommodate a sample and to enable optical detection of infection within said sample is provided. In this embodiment, the optical unit is a mirror (50) upon which said sample is placed and detected.

According to another embodiment the surface of said mirror is selected from a group comprising of planar surface, concave, surface, convex surface, hyperbolic, parabolic, conal shape or any combination thereof.

According to that embodiment the mouthpiece (70) has a flat, narrow opening with a flap at its distal end. The mouthpiece is opened when pushing the sides of it. The mouthpiece (70) is coupled to a retaining ring (74) at its proximal end. The retaining ring (74) retain within it the optical window/mirror (50). After the sample had been collected, the mouthpiece (70) is then pulled with the retaining ring (74). Once the mouthpiece (70) is pulled out of the elongated tube (10), the optical window/mirror (50) is release and rotates to about 270 degrees; thus, closing the elongated tube (10). Reference is now made to FIGS. 5A-5B, disclosing another embodiment of the sample collecting device (100). According to that embodiment the mouthpiece (70) has a flat, narrow opening with a flap at its distal end.

The mouthpiece (70) is coupled to a retaining ring (74) at its proximal end. After sample collection, the mouthpiece (70) is then pulled with the retaining ring (74). Once the mouthpiece (70) is pulled out of the elongated tube (10), the optical window/mirror (50) is release and rotates to about 270 degrees; thus, closing the elongated tube (10).

It should be emphasized that the shape of the elongated tube (10), as any of the embodiment of the present invention, might be in the form of a cylinder or in the form of a cone.

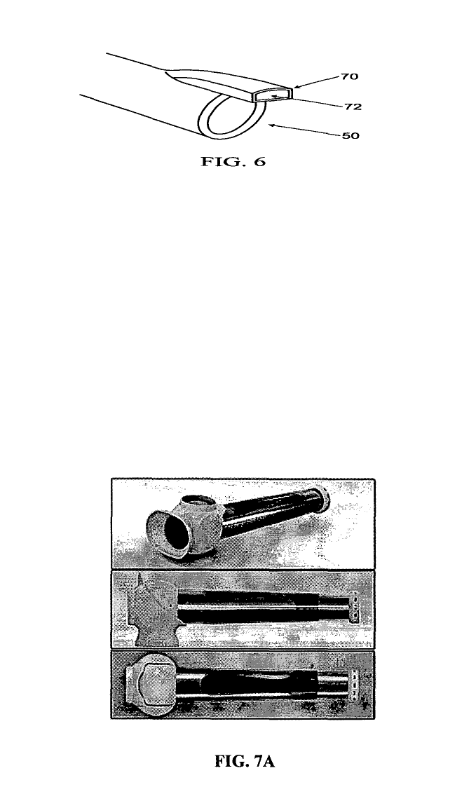

FIG. 6 schematically represents another embodiment of the droplet collecting device (100), wherein the mouthpiece (70) is not on the same longitudinal axis as the elongated tube (10), but protrudes from its side. It also has a hatchway (72) at its proximal end. In this embodiment the optical window/mirror (50) is permanently connected to the elongated tube (10).

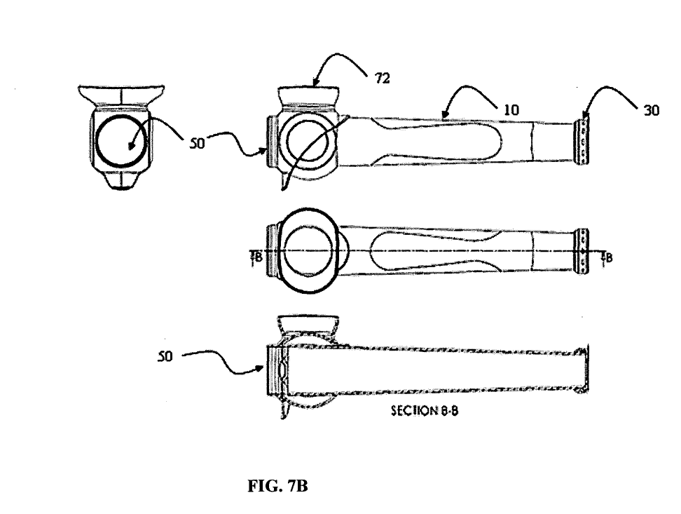

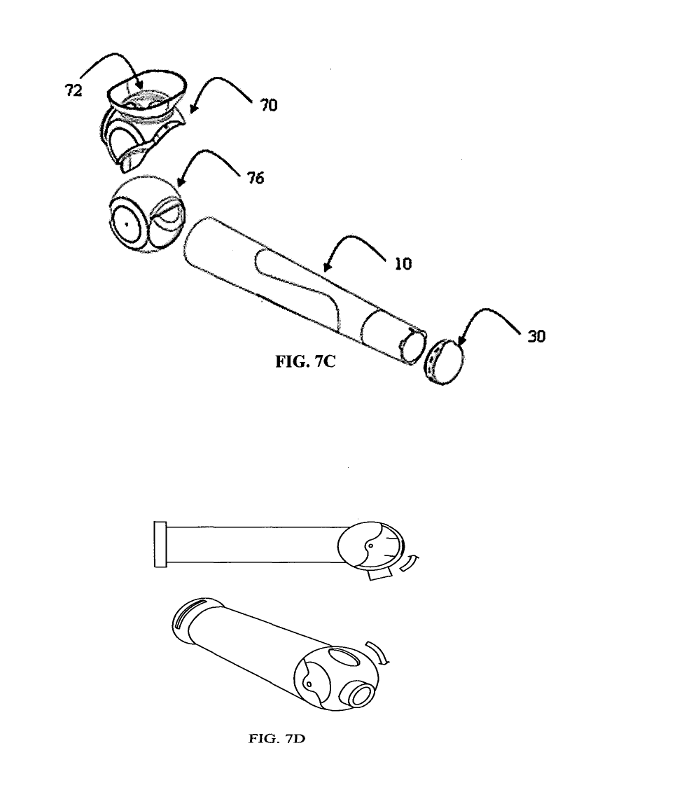

FIGS. 7A-7D schematically represents another embodiment of the sample collecting device (100), wherein the mouthpiece (70) is built as a hinge joint. The axis (76) of the joint is round and has an opening facing the longitudinal axis of the elongated tube (10). The socket (i.e., the mouthpiece (70)) covering the joint has two openings—one functions as an opening of the droplet collecting device (100) and is covered with a one way hatchway (72). The other opening is an optical window/mirror (50). At the initial position, the optical window/mirror (32) blocks the tube (10). As the sample is taken, the hatchway (72) opening is turned to face the longitudinal axis of the elongated tube (10). Immediately afterwards the joint is turned till the optical window/mirror (50) covers the droplet collecting device (100). This method assures that the droplet collecting device (100) isn't exposed to contaminated environment at any time.

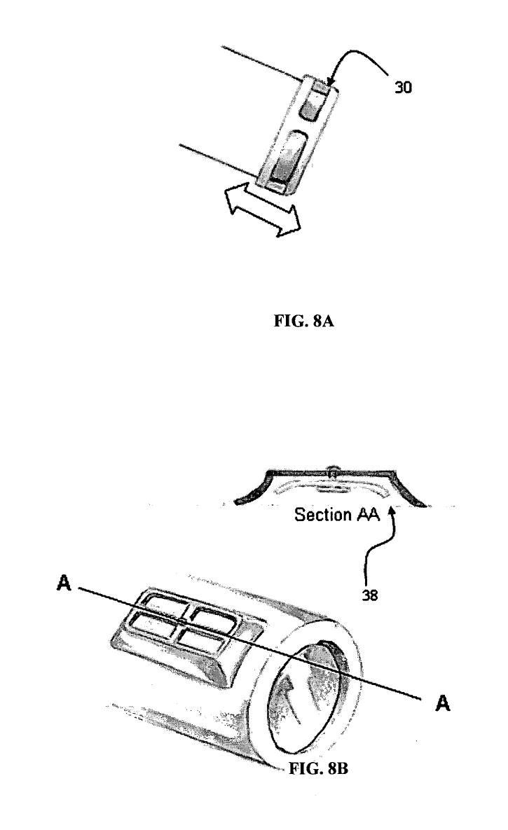

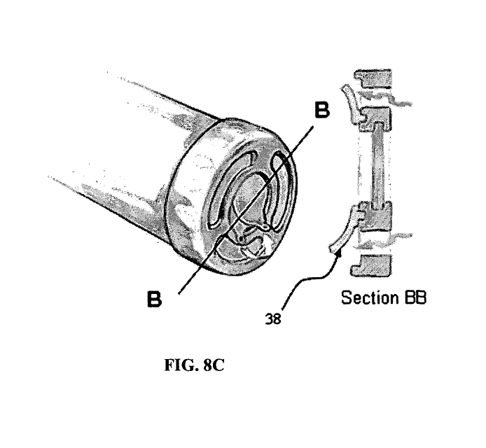

FIGS. 8A-8C schematically shows various embodiments of a check valve (30). The role of the check valve is to decompress the sample collecting device (100) as a large volume of air enters it during coughing, while avoiding contamination and exposure to the environment at another time. In the preferred embodiment, the check valve (30) moves along the longitudinal axis of the body (10) during the coughing phase (FIG. 8A). It has small apertures around it, which enables the escape of the access volume of air. A spring retracts it to its closed position after decompression of the droplet collecting device (100). In another embodiment, the check valve is made of a diaphragm (38) (see FIG. 8B), which opens the valve apertures only during the coughing phase. The check valve can be either on the side (FIG. 8B) or at the end (FIG. 8C) of the elongated tube (10).

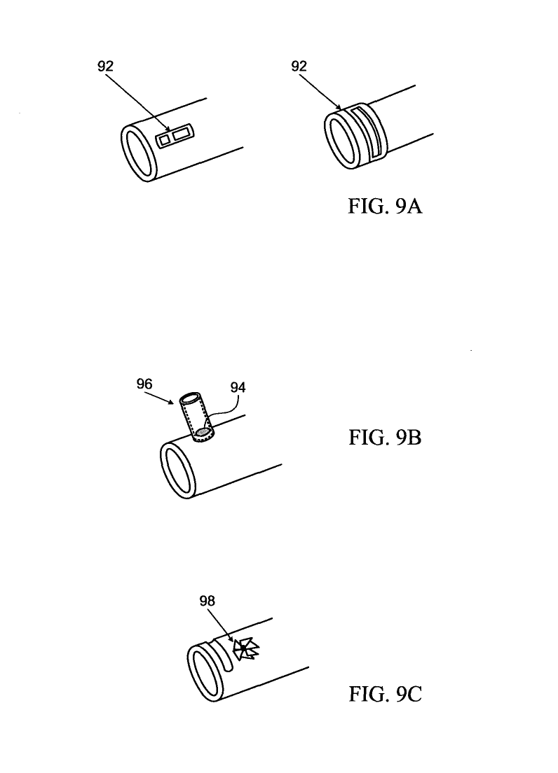

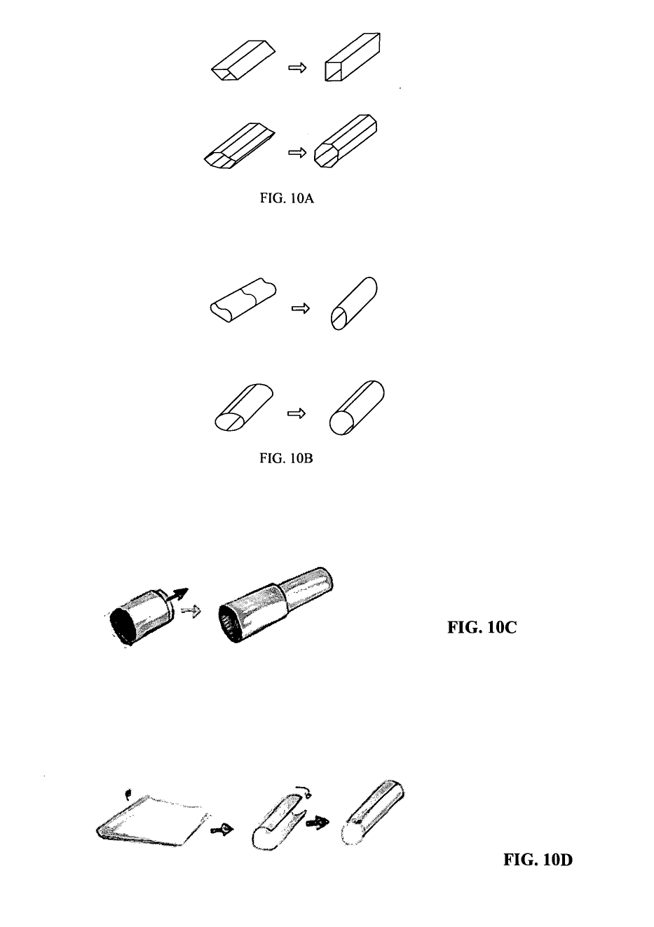

FIGS. 9A-9C schematically represents indicators for sample quantity (90). One way to assure an adequate sample size is to quantify the air volume entering the droplet collecting device (100) during the coughing phase. Since a user might cough outside the droplet collecting device (100) or not exert enough aerosol volume, it is beneficial to have an indicator of the air volume entering the elongated tube (10). Embodiments of such indicators include, in a non limiting manner, a humidity indicator (92) on the body (e.g., elongated tube) (10) or on the check valve (30), changing its color as it contacts a predetermined amount of humidic breath (FIG. 9A); a piston (94) which changes position as air is blown through a cylinder (96) connected to the lumen of the elongated tube (10) (FIG. 9B); or a movement indicator such as a rotor (98), which changes position as air sweeps through a slit in the elongated tube (10).

FIGS. 10A-D schematically illustrates embodiments of a folding elongated tube (10). This option is especially advantageous for a droplet collecting device (100) which is disposable, or made of flexible material. Embodiments of a folding elongated tube (10) include, in a non limiting manner, a body (e.g. an elongated tube) (10) in a polyhedron shape, collapsible on its edges (FIG. 10A); an elongated tube (10) which is collapsible on its longitudinal axis (FIG. 10B); an elongated tube (10) with a telescopic extension (FIG. 10C); and an elongated tube (10) which is rolled from a flat sheet.

2. Optical Optimizing Means

a. Optical Optimizing Means—Optical Cell

The present invention also provides means coupled to, in communication with or embedded within the optical unit adapted to increase the OPL.

As described above, one embodiment of the present invention provides an optical cell which is based on reflecting the light from the walls of the sampling cell. In addition to the above, the cross section area is made of multilayer structure, i.e., the walls could be coated with several different or identical layers.

According to one embodiment of the present invention, the OPL increase is achieved by coating the internal walls of the optical cell with at least one metal layer selected from a group consisting of Au, Ag, Al, Cu etc. or any combination thereof.

According to another embodiment of the present invention, the maximum OPL and minimum attenuation is achieved by coating said cell with at least one dielectric layer selected from a group consisting of AgI, CdS, CdSe etc. or any combination thereof.

According to another embodiment of the present invention, the maximum OPL and minimum attenuation is achieved by coating said cell with at least one metal layer and one dielectric layer.

The layers thickness is optimize to reflect a certain wavelength range. The optimization is achieved by maximizing the reflection from a thin layer according to the following equation:

$$R = \frac{{r}_{1}^{2} + {r}_{2}^{2} + 2 {r}_{1} {r}_{2} cos ( 2 δ )}{1 + {r}_{1}^{2} {r}_{2}^{2} + 2 {r}_{1} {r}_{2} cos ( 2 δ )}$$

In which R is the reflection coefficients of all the layers.

r—are the Fersnel reflection coefficients of each layer

and δ is a function layer thickness.

$$δ = \frac{2 π}{λ} {n}_{1} d cos ( {φ}_{1} ) ,$$

where d is the layer thickness, φ₁ is the angle of incidence, n₁ is the index of refraction of the layer and λ is the wavelength.

Typical thickness of a dielectric layer for reflecting light in the IR region is 0.0002 mm.

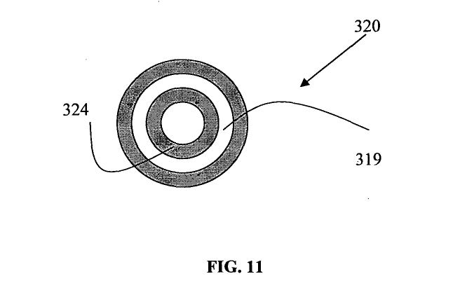

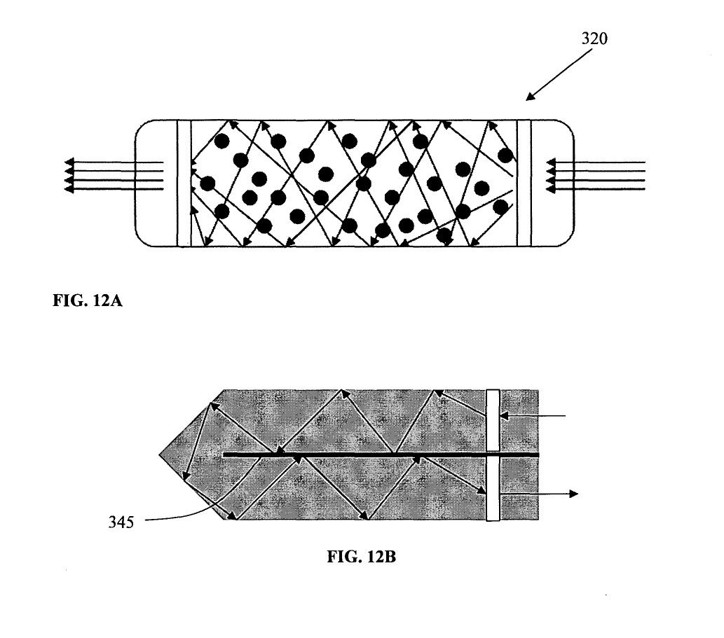

Reference is now made to FIG. 11 which illustrates a cross section area of the optical cell according to a preferred embodiment of the present invention. The optical cell comprises multiple layers coating the internal walls of the cell. The coating layers are selected, in a non limiting manner, from a group selected from at least one metal layer 324 followed by at least one dielectric layer 319 or any combination thereof. It should be pointed out that the optical cell is not limited to one metal layer or dielectric layer and additional layer may be added.

Reference is now made to FIG. 12A which illustrates the OPL while using the optical cell as described in the present invention. As can be seen from the figure the OPL is increase by at least 50% than the actual/physical length of the optical cell.

Furthermore, the optical cell 320 is especially adapted so as to minimize to blind spots.

According to another embodiment of the present invention the OPL can be increased by “folding” the optical path several times. Reference is now made to FIG. 12B which illustrate an optical cell folded into two. As can be seen from the figure, mirror 345 reflects the light so as to increase the OPL.

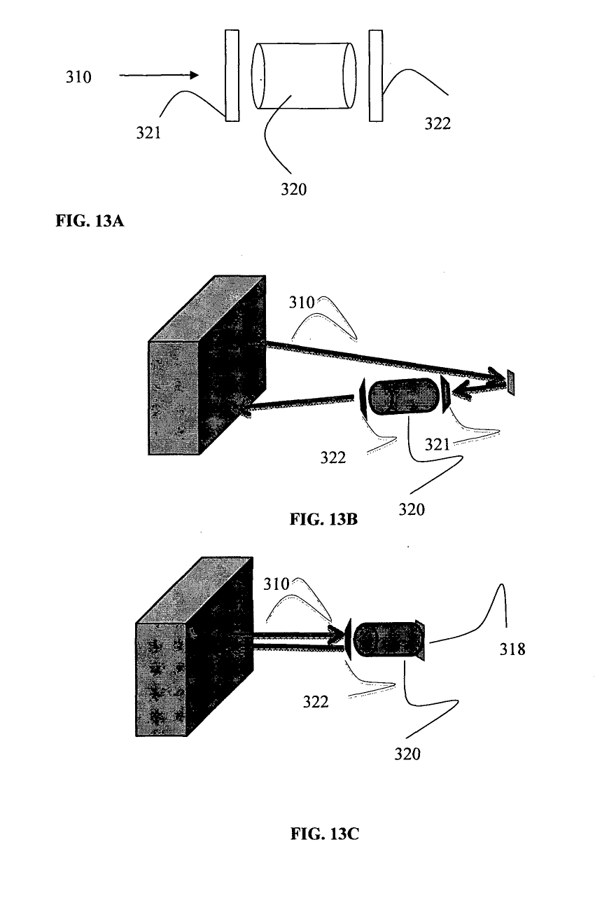

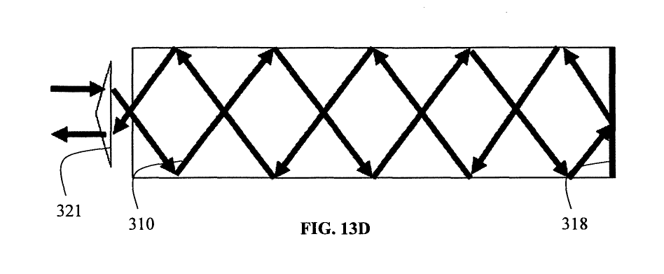

According to another embodiment of the present invention the OPL can be increased by using a mirror 318 as can be seen in FIG. 13D.

Another option to increase the OPL is by coupling to the optical cell beam shaping means. Said beam shaping means can be coupled to the optical cell in the entrance position and/or in its exit position.

The entrance beam shaping means and/or the exit beam shaping means can be selected from a group consisting of lenses, prisms, mirrors, OEM optical element, axicon or any combination thereof.

The entrance and exit beam shaping means can additionally be selected and adjusted for optimal light distribution inside the optical cell. The light distribution depends on the optical cell shape, length, material etc. Such optimal distribution can be determined by a simulation, which comprises inter alia steps of:
1. selecting two sets of optical components and running the optical simulation for each set of optical components;
2. For each set, calculating the transmission and the light distribution per unit length;
3. changing the angle of incidence of the light inside the optical cell by changing the focal length of the lenses or the dispersion angle of the prisms or axicons to achieve reasonable attenuation and maximal light coverage of the optical cell;
4. Optimizing the angle of incidence according to the system sensitivity so that enough light will reach the detector and in the same time the optical cell will be fully illuminated.

Attention is drawn to FIGS. 13A and 13B, schematically showing entrance beam shaping means 321 adapted to shape the light source beam 310 in order to maximize the light path length through an optical cell and to minimize blind spots. Additionally or alternatively the optical cell may be in communication with exit beam shaping means 322 adapted to collect the light that is coming out of the optical cell and guiding it to the detector (i.e., the detecting means which will be discussed later). Said exit beam shaping means 322 can be in some embodiments a mirror.

Alternatively, an entrance beam shaping means can be positioned at the entrance to the optical cell, and a reflecting means, such as a mirror 318, can be positioned behind the optical cell, in such a way that the beam of light 310 will pass through the entrance beam shaping means and through the optical cell twice, as is illustrated in FIG. 13C. FIG. 13D illustrates an example of the optical path of beam of light 310 within the optical cell. According to the embodiment illustrated in FIG. 13D, the optical cell comprises entrance beam shaping means 321 and a mirror 318 enabling a second interaction between the light and the sample and only then to exit from the optical cell.

The entrance and exit of light into the optical cell 320 is enabled by coupling to the optical cell at least two optical window/mirrors 50.

The optical windows/mirrors (50) can be made from materials selected from a group consisting of Polyethylene, PTFE, propylene, polydiene, polyamides, polystyrene and copolymers thereof, polyethylene, ethylene-octene copolymer, polyvinylpyrrolidene, poly(acenaphthylene), styrene/ethylene-butylene copolymer, poly(1-butene), polymers of the ammonium salt of acrylic acid, ethylene/propylene copolymer and ethylene/propylene/diene terpolymer, which are transparent at the required wavelength and neoprene, polyurethane, fluorelastomer, polycarbonate, polyether sulfone, polyether ether-ketone, and polyacrylate and/or glass, or a crystal that are transparent in the required wavelength range.

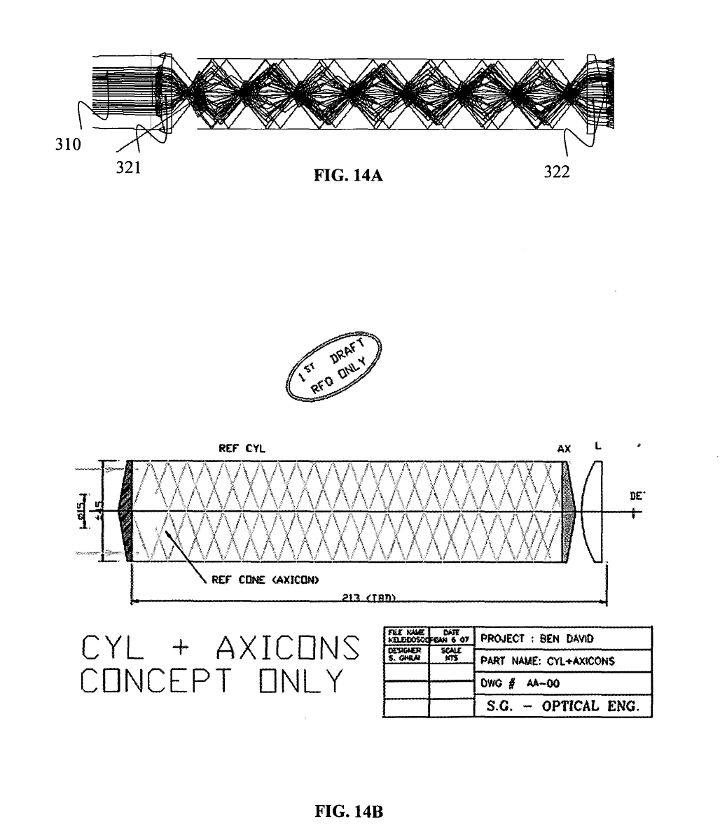

An example of optical simulation using two axicons as entrance and exit beam shaping means, at a propagation angle of 45° and 75°, is schematically shown in FIGS. 14A and 14B respectively.

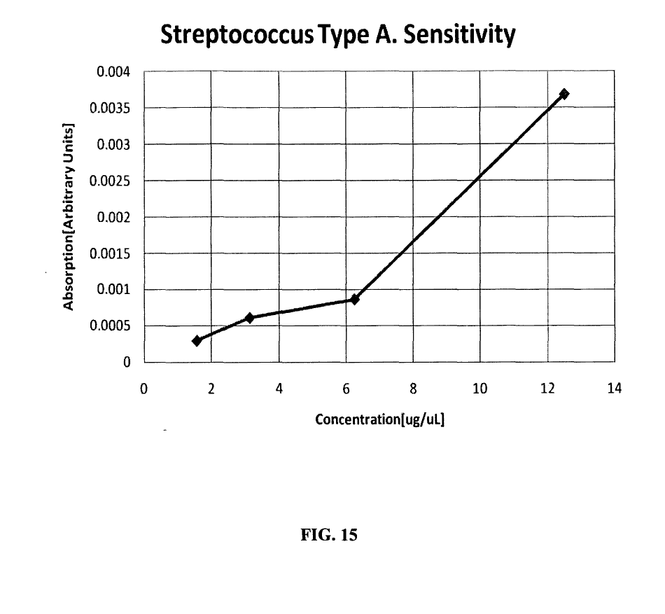

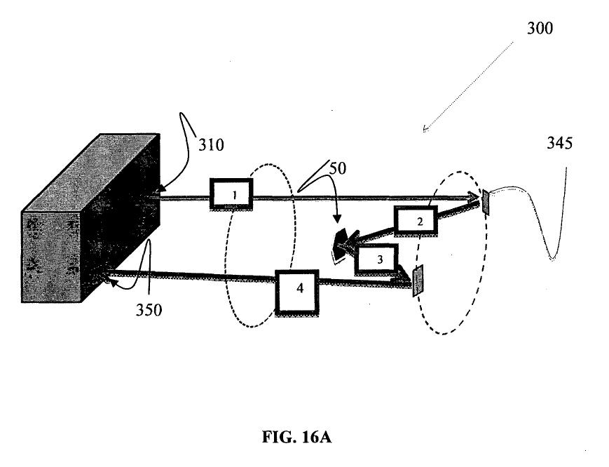

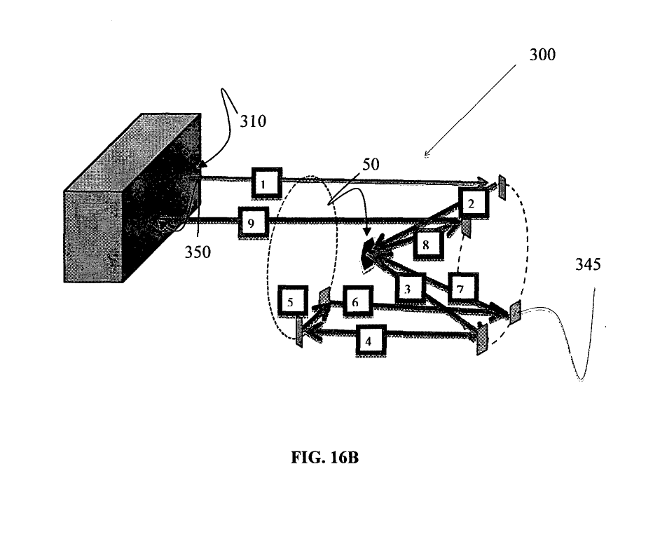

An example of the systems sensitivity to the detection of Strep. A bacteria is shown in FIG. 15. As can be seen from the graph, as the bacterial concentration increases in the optical cell, the absorption signal increases. The graph shows that the system can detect a concentration of less than 2 μg/μL Sterp. A bacteria (more data is given in example 2).

b. Optical Optimizing Means—Optical Window/Mirror

The more times light is reflected from the surface of an optical window/mirror (50), the more the detection of pathogens deposited on it is improved.

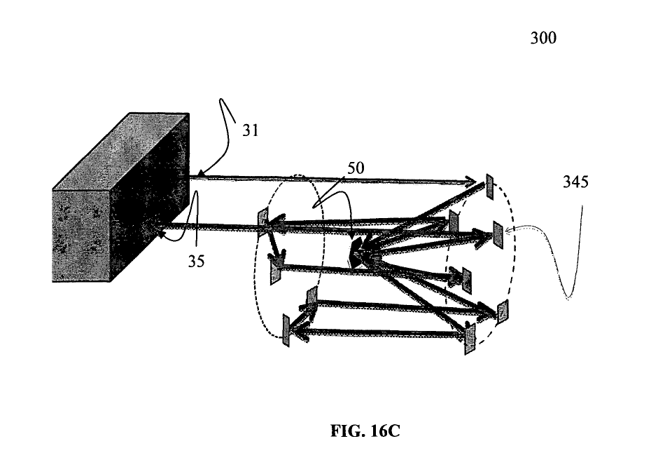

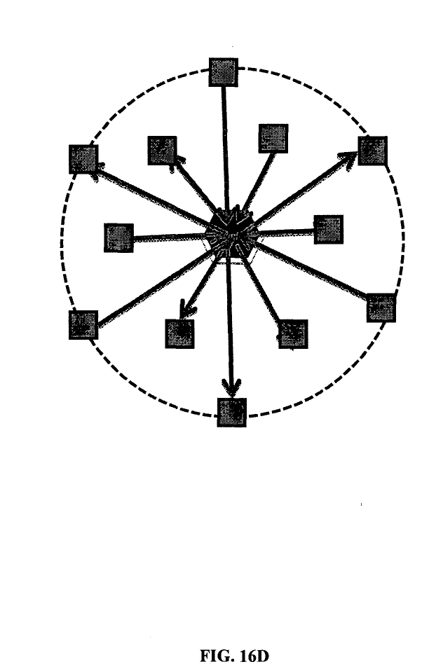

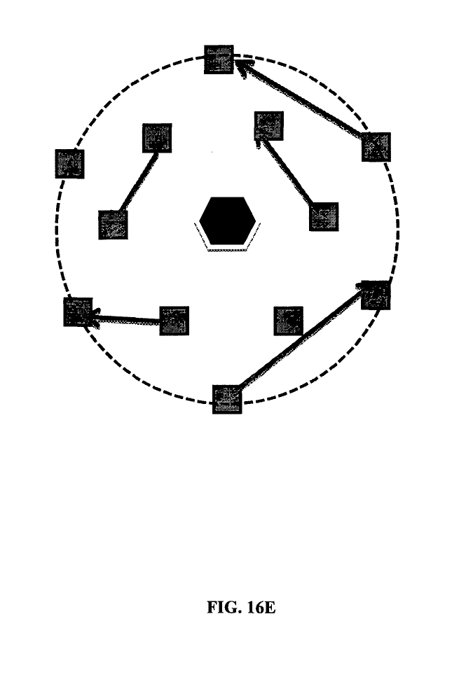

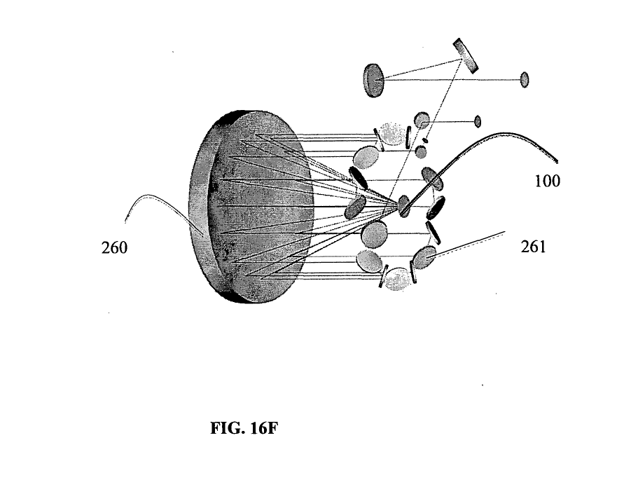

Attention is drawn to FIGS. 16A-16E, schematically showing spectrometric measurement setup 300, adapted for an optical window/mirror (50), consisting of many mirrors 345 increasing the number of times light hits the optical window/mirror (50). The more mirrors are integrated in the reflection system, the more reflections are achieved and the larger the OPL through the sample—in FIG. 16A the optical window/mirror (50) is hit once (the light beam hits are numbered in a serial numbering from 1-4), in FIG. 16B it is hit twice (the light beam hits are numbered in a serial numbering from 1-6), in FIG. 16C it is hit three times.

A front and a rear view of the configuration for multiple hits is illustrated in FIGS. 16D and 16E respectively. It is obvious, to a person skilled in the art, that more configurations of mirrors 345 are possible, with varying number of mirrors, in manner which increases the number of hits. Furthermore, lenses or other optical means can be incorporated in the reflection system, so that a better coverage of the optical window/mirror (50) is achieved.

It should be emphasized that some of the main advantages of the system as described above will enable the detection of bacteria within the optical window/mirror (50) even if the beam of light emitted out of the light source 310 is not collimated (i.e., parallel).

Further it should be emphasized that, contrary to known thin disc laser, the light beam should not be focused on the center of the optical window/mirror (50), but it should impact, as much as possible, on the entire surface of the optical window/mirror (50).

FIG. 16F illustrates the use of a parabolic mirror for increasing the interaction between the sample and light. The figure illustrates the parabolic mirror (260) combined with several adjustable mirrors 261 and the optical unit (100). As can be seen from the figure, there are multiple interactions of the light beam with the sample in the optical unit (100).

3. Optical Detection System

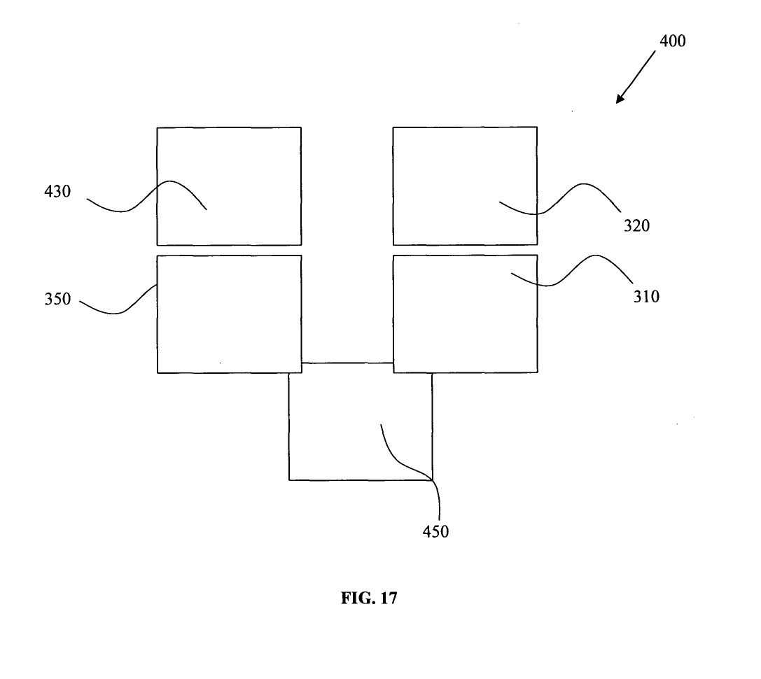

The present invention also provides an optical detection system 400. Reference is now made to FIG. 17 schematically illustrating an optical detection system 400 according to the present invention. The optical detection system (400) is especially adapted to identify bacteria within a sample. The optical detection device 400 comprises, in a non limiting manner, the following units:
1. At least one optical unit (320) (as described above) which is adapted to accommodate the sample as described in the present invention;
2. Means coupled to, in communication with or embedded within the optical cell adapted to increase the OPL or the optical unit surface exposure
3. At least one light source (310). The light source is adapted to emit light to the optical unit.
4. Detecting means, especially spectrometer, (350) adapted to receive the spectroscopic data of the sample by collecting the light exiting from the optical unit.
5. Processing means (450) in communication with the detecting means, adapted to (i) analyze the spectroscopic data and to (ii) detect the presence of the bacteria within the sample.

The optical detection device 400 may additionally comprise a nose-mouth mask (430) adapted to be reversibly coupled to the optical unit (320) and to be placed on the patient's mouth and nose to enable the collection of the sample, i.e., cough debris into or on the optical unit.

According to one embodiment, the optical detection system 400 may additionally comprise displaying means—in communication with the processing means adapted to display the test results (i.e. whether bacteria were found and if so—of what kind).

The optical detection system 400 is designed such that the minimum bacteria concentration needed for said detection in said optical unit is lower than 0.5 times than the minimum bacteria concentration needed for said detection in a standard (conventional) optical cell. Furthermore, optical detection system 400 is designed such that the minimum amount C of said bacteria within the sample needed for said detection is lower than 5×10⁵ bacteria.

One of the major advantages of the optical detection system 400 as provided by the present invention is the ability to detect the bacteria as a whole.

The optical signature of the whole bacteria (as opposed to different proteins of the bacteria like protein M on its surface) is a superior method for detecting bacteria as the spectral signature is specific for the bacteria itself and cross talk between different bacteria strains, that share the same type of protein and thus give a false positive result, is almost a nonexistent factor in the present invention.

Furthermore, if one type of Strep. Pyogenes is sensitive to antibiotics and another Strep Pyogenes is not—the test that examines the M protein will not be able to differentiate between the two. Therefore the detection method is able to distinguish between antibiotic resistant bacteria and antibiotic sensitive bacteria.

The optical detection system (400) operates as follows: first the nose-mouth mask (430) is coupled to the optical unit and placed on the mouth of the patient and the cough debris is collected into the optical unit. Alternatively the doctor/nurse will take a swab and collect the biological sample (for example from the throat or nose) and smear it on the optical cell. Then, the optical cell is placed within a spectrometer, the light source (310) emits light at different wavelengths and the spectroscopic characteristics (i.e. the absorption spectrum) of the sample are measured by the detecting means 350. Lastly by analyzing the absorption spectrum of the cough content, the device indicates whether bacteria were found or not, and if so, which type.

It should be pointed out that the after the collection of the cough debris the nose-mouth mask (430) can be de-coupled from the optical unit and only the optical unit is inserted into the spectrometer (i.e. without the nose-mouth mask (430)).

It is acknowledged that the light source (310) may incorporate several light sources and beam shaping optics. Furthermore, the light source (310) emits light to the sample (within the optical cell 320) at the spectral range that corresponds to the absorption lines of the desired bacteria and possible interferences.

The optical detection system (400) may additionally comprise a control unit adapted to allow the following functions: an interface with the user, light source control, importing spectroscopic absorption spectrum of different bacteria and storing the results of the analysis.

According to another embodiment, the system (400) may recommend the user (or physician) what kind or medicine (e.g., antibiotics) to take.

According to yet another embodiment of the present invention the optical detection system (400) may be utilized within a hospital environment or other clinic environment. Furthermore the optical detection device is designed to operate by a single operator that may not have any preliminary qualifications (e.g. medical staff).

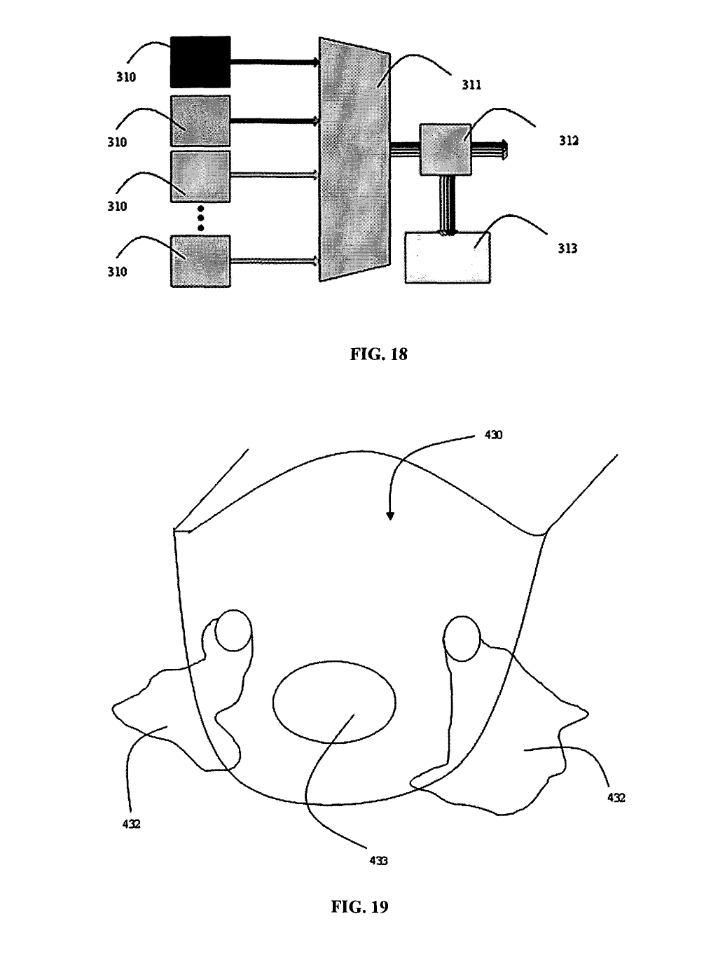

Reference is now made to FIG. 18, which illustrates the n light sources (310) that are incorporated within said optical detection system (400). n is an integer equal/greater than 1. Those n light sources form a co-aligned beam that enters the optical unit 320 and interacts with the sample.

The light source can be selected from a group consisting of a lamp with a broad wavelength range, discrete lasers, LEDs, a tunable light source or any combination thereof. According to one embodiment of the present invention, all the light sources (310) will be coupled using an optical coupler or beam combiner (311) to form a co-aligned beam. The light beam can be then split in about 99%:1% ratio by using a beam splitter (312). The beam is split for the purposes of monitoring the light sources output power. Thus, about 99% of the light beam is directed towards the sample (i.e. to the optical unit 320) and about 1% is directed towards a reference detector (313).

The light source emits light in the range of the wavelength needed for detecting the bacteria. The range at which the light is emitted can be selected from a group consisting of UV, visible, near-IR, mid-IR, far IR and terahertz range.

Another option to ensure that the cough content will not leak out to the surrounding is by coupling to the nose-mouth mask (430) to at least one container (432) for containing the residual cough debris.

Reference is now made to FIG. 19 illustrating said embodiment. According to that embodiment, the nose-mouth mask (430) comprises at least one container (432) for the residual cough debris. The container (432) is adapted to contain the residual cough content after the optical cell had reached its highest capacity. Numerical reference 433 denotes the main air input to the optical cell.

According to another embodiment of the present invention, the optical unit provided by the present invention is especially adapted to a single use. According to this embodiment, an RD ID chip which comprises a unit code is provided. In the first use of the optical unit, the detecting means, e.g., the spectrometer and/or the processing means, will save the code. A second use of the same optical unit will not be enabled.

Another option to ensure a single use of the optical unit is by adding at least one firing-pin adapted to perforate or pierce or puncture or search the optical unit so as to render it useless in the second use.

According to another embodiment of the present invention, special means are provided to ensure the originality of the optical unit. According to this embodiment, a dedicated RDIF chip can be provided having a unique code, which will be read at a later point of the diagnostic, which will ensure that the optical unit is original.

Another option is to incorporate into the optical unit an absorbing element. Said absorbing element will have a unique spectral signature which will be recognized at a later point of the diagnostic. The recognition of said spectral signature will ensure that the optical unit is original.

### EXAMPLES

Examples are given in order to prove the embodiments claimed in the present invention. The examples describe the manner and process of the present invention and set forth the best mode contemplated by the inventors for carrying out the invention, but are not to be construed as limiting the invention.

### Example 1

### Calculating the OPL

Reference is now made to FIG. 20 illustrating the propagation of a light beam within an optical cell.

Let us look at a tube with length L and a cross-section R.

The ray propagates at an angle θ.

The optical path length between two hits on the optical cell wall, x, is given by

$$x = \frac{2 R}{cos ( θ )}$$

The number of path lengths is given by

$$n = int [ \frac{L}{y} ] = int [ \frac{L}{2 R tan ( θ )} ]$$

The total optical path length

$${L}_{path length} = nx = ( int [ \frac{L}{2 R tan ( θ )} ] ) \frac{2 R}{cos ( θ )}$$

It is possible to see that the path length is independent of R if the optical cell is symmetric. In that case the optical path length per optical cell unit length is

$$\frac{1}{sin ( θ )}$$

### Example 2

### The Systems Sensitivity

Reference is now made again to FIG. 15, depicting the dynamic range of the system. As the bacterial concentration in the optical cell 320 increases, more light is absorbed in the optical system. The graph shows that the system can detect a concentration of less than 2 μg/μL Sterp. A bacteria.

### Example 3

### Tube Coating

Reference is now made to FIG. 21, illustrating a possible method of coating the elongated tube constituting the optical cell, for increasing the OPL. The internal surface of the glass tube is cleaned, etched and activated prior to the guiding layer preparation (silver mirror and silver iodide) using the procedure described in FIG. 21. The samples are rinsed after each step in DI water. After AgI deposition the tubes are rinsed in ethanol and dried in nitrogen.

### Example 4

### Distinguishing Between MRSA and MSSA

The following example demonstrates that a distinction can be made between MRSA and MSSA.

The system was tested using 74 samples of MSSA and 91 samples of MRSA.

The calculated sensitivity and specificity are 98.66% and 100% respectively.

Experimental Protocol
1. A strip of bacteria is removed from the agar plate (via a quadloop) and the same us dissolved in an eppendorf tube with 400 μl ddH2O (Sigma-Aldrich W3500—100 mL).
2. 30 μL from every tube is put on an area on an optical plate (ZnSe).
3. The plate is placed in a desiccator (Dessicator 250 mm polypropylene, Yavin Yeda) in the presence of several petri plates with a desiccant agent (Phosphorus Pentoxide cat #79610 Sigma Aldrich) and vacuum is used for 30 minutes.
4. The spectral signature is read:
5. The spectral analysis is performed. The analysis provides the differentiation between the resistant and sensitive bacteria.

It should be pointed out that the same experimental protocol was performed to each of the following bacteria.

Blood MSSA vs. Blood MRSA

Reference is now made to FIG. 22 illustrating the differentiation between samples of blood with MRSA and MSSA.

In the graph, the x-axis represents Feature #1 which is the value at 1094.6233 cm⁻¹ of the min-max normalized of the 2^{nd} derivate in the region [925 1190] cm⁻¹, where the derivative was calculated on the max normalized absorbance signal in the region [925 1190] cm⁻¹ after its baseline was subtracted.

The Y-axis represents Feature #2 which is the value at 1070.2346 cm⁻¹ of the min-max normalized of the 1^{st} derivate in the region [925 1190] cm⁻¹, where the derivative was calculated on the max normalized absorbance signal in the region [925 1190] cm⁻¹ after its baseline was subtracted.

As is clear from the figure, the blood samples containing MRSA and/or MSSA can be identified individually.

### Swab Samples

### Experimental Protocol for the Swabbing Experiments

1. A Copan cotton swab is used to pick up human fluid sample in duplicates.
   a. Swab #1—human fluid without bacteria.
   b. Swab #2—pick up 1-5 CFUs from a MRSA or MSSA plate.
2. Do reference reading of the optical cell.
3. Apply each of the swabs on the optical cell.
4. Read the spectral signature
5. Analyze the recorded data
   NoseMSSA vs. NoseMRSA

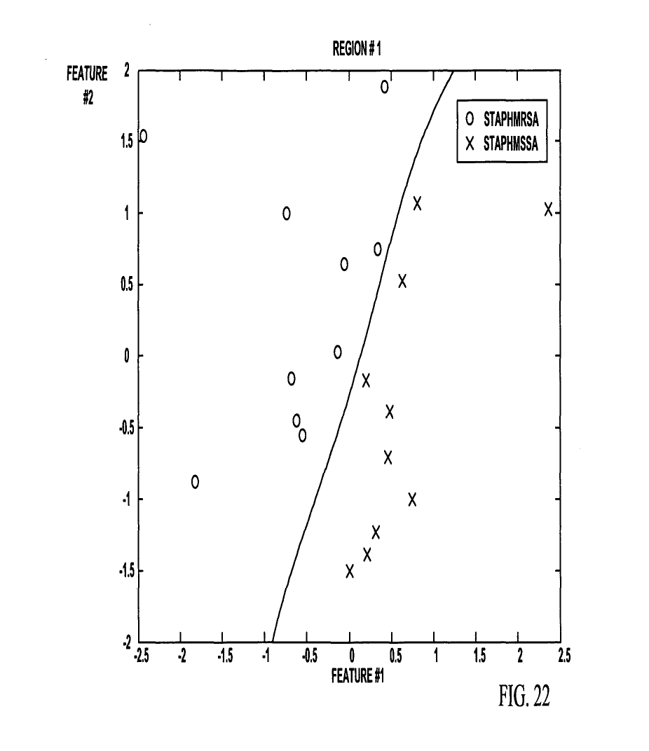

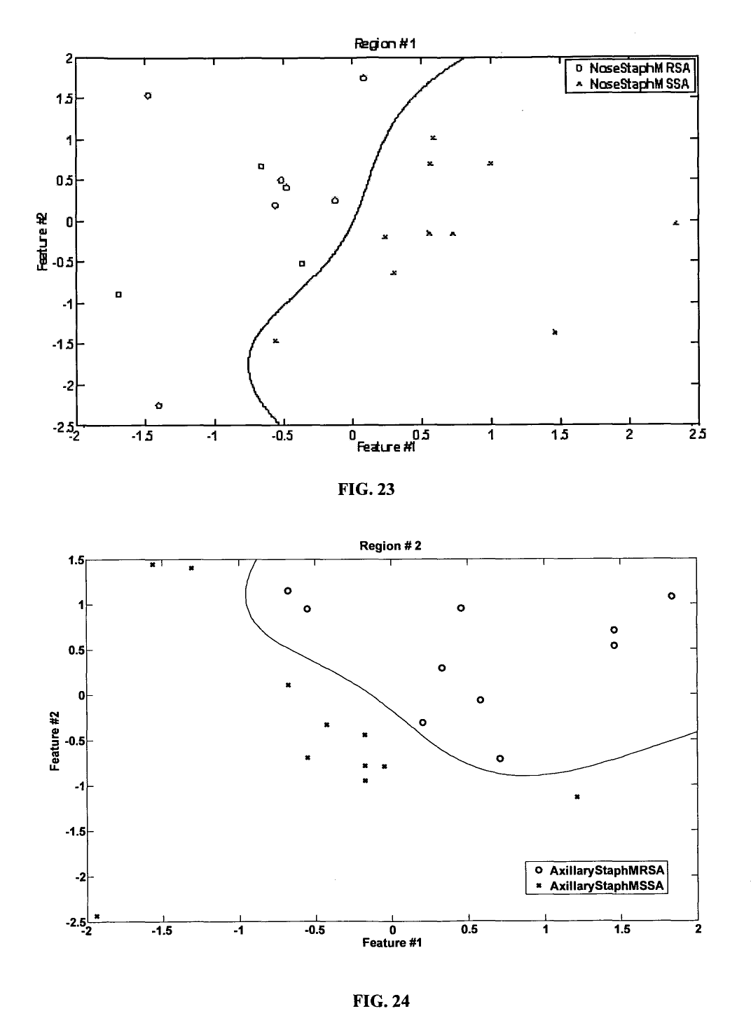

Reference is now made to FIG. 23 illustrating the differentiation between nose swabs samples spiked with MRSA and MSSA.

In the graph, the x-axis represents Feature #1 which is the value at 1065.9307 cm⁻¹ of the min-max normalized of the 2^{nd} derivate in the region [925 1190] cm⁻¹, where the derivative was calculated on the max normalized absorbance signal in the region [925 1190] cm⁻¹ after its baseline was subtracted.

The Y-axis represents Feature #2 which is the value at 974.1144 cm⁻¹ of the min-max normalized of the 2^{nd} derivate in the region [925 1190] cm⁻¹, where the derivative was calculated on the max normalized absorbance signal in the region [925 1190] cm⁻¹ after its baseline was subtracted.

As is clear from the figure, the nose swabs samples spiked with MRSA and/or MSSA can be identified individually.

AxillaryMSSA vs. AxillaryMRSA

Reference is now made to FIG. 24 illustrating the differentiation between axillary swabs spiked with MRSA and MSSA:

In the graph, the x-axis represents Feature #1 which is the width of the peak measured from 1650 cm⁻¹ to the half of its magnitude of the value at 1650 cm⁻¹ in the max normalized signal in the region [1458 1800] cm⁻¹ after its baseline was subtracted.

The Y-axis represents Feature #2 which is the cD1(95)—coefficient # 95 in the approximation of level # 1 with db2 wavelet transform, where db2 is the Daubechies family wavelet of order 2. The transformation was applied on the max normalized signal in the region [1458 1800] cm⁻¹ after its baseline was subtracted.

As is clear from the figure, the axillary swabs spiked with MRSA and/or MSSA can be identified individually.

### Example 5

### Swab on the Optical Cell+Strep Payo Spiking

1. Strep Payo or MSSA or MRSA were seeded in an isolation growth.
2. The procedure was explained to healthy volunteers. It was explained to them that their participation in the trial is voluntary and their reluctance to participate will not be held against them in any case. If they agreed to participate, they were signed on the protocol.
3. Three swabs were taken from the volunteer and treated according to the following table:

| | | | | | |
|---|---|---|---|---|---|
| | | | CFU | | |
| Volunteer | | | from | Signal | Result according to |
| signature | Swab | bacteria | plate | quality | classifier |

| | | |
|---|---|---|
| 1 | 1 | — |
| | 2 | MRSA |
| | 3 | Strep |
| | | Payo |

4. After the swab was taken from the glandular area, bacteria was added from the plate according to the table above (aim for 1-5 CFUs).
5. The content of swab was distributed on the optical cell in a timely manner, according to the table.
6. The plate was moved to optical system.
7. The spectral signature was read in the optical system.

Identifying Strep. Payo in a swab sample. 59 samples containing Payo were tested and 50 samples not containing Payo were tested. The following table summarizes the results obtained from the experiment:

| | Optical results | |
|---|---|---|
| | No. of | |
| | sampled which | No. of sampled which |
| | were identified as | were identified as NOT |
| real Samples | containing Payo. | containing Payo. |
| 59 samples containing Payo | 56 | 3 |
| 50 samples NOT containing | 2 | 48 |
| Payo | | |

The sensitivity was 96.00%
The specificity was 94.92%

The results were obtained by providing a 6 dimensioned graph. Each dimension represent one of the following feature:

Feature #1: The value of the correlation between the of the 2^{nd} derivate in the region [925 1190] cm⁻¹ and a reference 2^{nd} derivative in the same region [925 1190] cm⁻¹. The derivatives was calculated on the min-max normalized absorbance signal in the region [925 1190] cm⁻¹ after its baseline was subtracted.

Feature #2: cD1(67)—coefficient no. # 67 with db2 wavelet transform, where db2 is the Daubechies family wavelet of order 2. The transformation was applied on the min-max normalized signal in the region [925 1190] cm⁻¹ after its baseline was subtracted.

Feature #3: cD1(52)—coefficient no. # 52 with db2 wavelet transform, where db2 is the Daubechies family wavelet of order 2. The transformation was applied on the min-max normalized signal in the region [925 1190] cm⁻¹ after its baseline was subtracted.

Feature #4: The value at 1189.309 cm⁻¹ of the min-max normalized of the 2nd derivate in the region [925 1190] cm⁻¹, where the derivative was calculated on the min-max normalized absorbance signal in the region [925 1190] cm⁻¹ after its baseline was subtracted.

Feature #5: The value at 1022.8918 cm⁻¹ of the min-max normalized of the 2^{nd} derivate in the region [925 1190] cm⁻¹, where the derivative was calculated on the min-max normalized absorbance signal in the region [925 1190] cm⁻¹ after its baseline was subtracted.

Feature #6: The value at 1100.3619 cm⁻¹ of the min-max normalized of the 2nd derivate in the region [925 1190] cm⁻¹, where the derivative was calculated on the min-max normalized absorbance signal in the region [925 1190] cm⁻¹ after its baseline was subtracted.

### Example 6

### Cough Clinical Study

The following is a clinical trial in which 10 volunteers participated.

Protocol:
1. 20 healthy volunteers (or 10 volunteers for 2 samples each) for a total of 20 samples were used.
2. The entire procedure was explained to them. Furthermore, it was told them that their participation in the trial is voluntary and their reluctance to participate will not be held against them in any case. If they agree to participate, they were sign on the protocol.
3. The optical cell was cleaned using disinfectant and alcohol.
4. The mouth piece was coupled to the optical cell.
5. Each volunteer was asked to cough 5 forced true coughs into the mouth piece.
6. The mouth piece was disassembled from the optical cell;
7. The optical cell was moved to the optical system.
8. The spectral signature in the optical system was read.

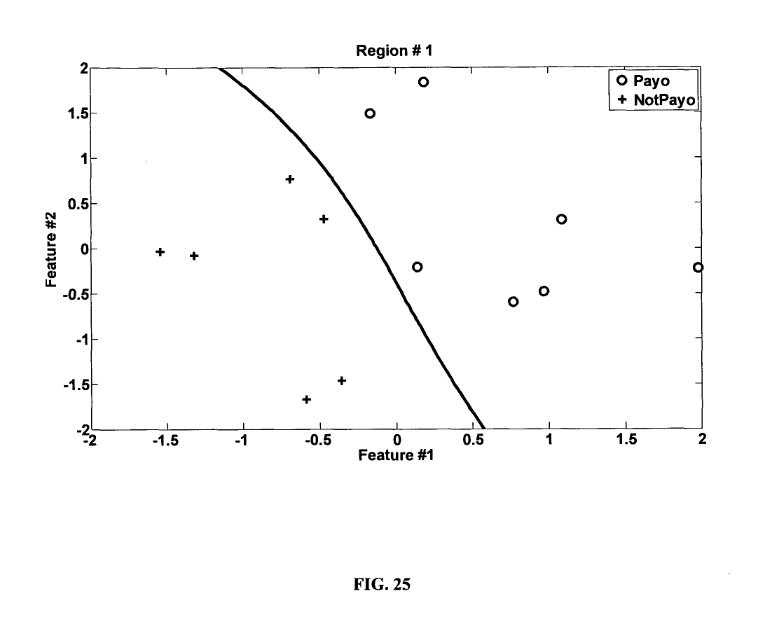

Reference is now made to FIG. 25 which is a scatter plot of the cough clinical study given above.

In the graph, the x-axis represents Feature #1 which is cD1(69)—coefficient # 69 with db2 wavelet transform, where db2 is the Daubechies family wavelet of order 2. The transformation was applied on the min-max normalized signal in the region [925 1190] cm⁻¹ after its baseline was subtracted.

The Y-axis represents Feature #2 which is the value at 1156.3125 cm⁻¹ of the min-max normalized of the 1^{st} derivate in the region [925-1190] cm⁻¹, where the derivative was calculated on the min-max normalized absorbance signal in the region [925-1190] cm⁻¹ after its baseline was subtracted.

1-78. (canceled)

79. An optical unit (320) adapted to accommodate a sample and to enable optical detection of infection within said sample; said optical unit comprising a body (10); wherein the internal surface of said body is highly reflected and has mirror-like optical properties; further wherein internal volume of said body is adapted to accommodate said sample.

80. The optical unit (320) according to claim 79, wherein said internal surface of said body (10) comprising at least one mirror (50); wherein said mirror (50) having at least one proximal surface and at least one distal surface; wherein said at least one proximal surface is adapted to accommodate said sample.

81. An optical unit (320) adapted to accommodate a sample and to enable optical detection of infection within said sample; wherein said optical unit is a mirror upon which said sample is placed.

82. The optical unit (320) according to claim 80, wherein said proximal surface has a surface chosen from a group comprising of planar surface, concave, surface, convex surface, hyperbolic, parabolic, conal shape.

83. The optical unit (320) according to claim 81, wherein the surface of said mirror is selected from a group comprising of planar surface, concave, surface, convex surface, hyperbolic, parabolic, conal shape.

84. The optical unit (320) according to claim 80, additionally comprising a double sided mirror disposed along the main longitudinal axis of said body.

85. The optical unit (320) according to claim 80, wherein at least one of the following is being held true (a) said optical window (50) is adapted to allow light beams to enter said body (10) such that said optical detection of said bacteria is enabled; (b) said optical window (50) is adapted to seal said elongated tube (10) such that contamination of said sample is minimized; (c) said body (10) additionally comprises at least one check valve (30) at least partially coupled to the same adapted to decompress large air volumes entering said elongated tube; (d) said optical unit (320) additionally comprising at least one mask at least partially reversibly coupled to the same, adapted to enable collection of said sample.

86. The optical unit (320) according to claim 80, wherein said sample is selected from an aerosol sample, a droplet sample or a swab sample.

87. The optical unit (320) according to claim 80, wherein said infection contains bacteria selected from a group consisting of Gram negative pathogens such as Various types of Acinetobacter, A. baumannii, Stenotrophomonas maltophilia, Gram positive pathogens such as Streptococcus pneumonia resistant to b lactamase and macrolides, Streptococcus viridians group resistant to b lactamase and aminoglycosides, enterococci resistant to vancomycin and teicoplanin and highly resistant to penicillins and aminoglycosides, Enterococcus Faecium, Enterococcus Faecalis, staphylococcus aureus SENSITIVE AND resistant to methicillin, other B lactams, macrolides, lincosamides and aminoglicozides. Streptococcus pyogenes resistant to macrolides, macrolide-resistant streptococci of groups B, C and G. Coagulase negative staphylococci resistant to b lactams, aminoglycosides, macrolides, lincosamides and glycopeptides, multiresistant strains of Listeria and corynebacterium, Peptostreptococcus and clostridium, C. Difficile, resistant to penicillins and macrolides, Haemophilus Influenza resistant to b lactamase, Pseudomonas Aeruginosa, Stenotrophomonas Maltophilia, Klebsiella Pneumonia resistant to antibiotics Klebsiella Pneumonia Resistant to carbapenem, Klebsiella Pneumonia sensitive to antibiotics, aminoglycosides and macrolides or any combination thereof; further wherein said detection is made by detecting the absorption spectrum specific for said bacteria.

88. The optical unit (320) according to claim 80, wherein said body is adapted to enhance the interaction between light and said sample within said tube; further wherein said body is adapted to minimize the attenuation due to reflection from said elongated tube walls and blind spots; further wherein the internal surface of said body are coated with at least one reflecting coating layer selected from (a) at least one metal layer selected from a group consisting of Au, Ag, Al, Cu or any combination thereof; (b) at least one dielectric layer selected from a group consisting of AgI, CdS, CdSe or any combination thereof; (c) at least one metal layer and one dielectric layer; or any combination thereof.

89. The optical unit (320) according to claim 80, wherein at least one of the following is being held true (a) said body additionally comprises an indicator for quantifying said sample; (b) said body is single use and disposable; (c) said optical unit additionally comprising an RF ID chip utilizing a code such that once said code was read no additional use of said optical unit is enabled.

90. The optical unit (320) according to claim 80, wherein said sample is collected from a group consisting of swab, fluid by a capillary tube, humans or animals or non medical material.

91. The optical unit (320) according to claim 80, wherein said detection of said infection is determined from said spectroscopic data in the region of about 3000-3300 cm⁻¹ and/or about 850-1000 cm⁻¹ and/or about 1300-1350 cm⁻¹, and/or about 2836-2995 cm⁻¹, and/or about 1720-1780 cm⁻¹, and/or about 1550-1650 cm⁻¹, and/or about 1235-1363 cm⁻¹, and/or about 990-1190 cm⁻¹ and/or about 1500-1800 cm⁻¹ and/or about 2800-3050 cm⁻¹ and/or about 1180-1290 cm⁻¹.

92. An optical detection system for identifying an infection within a sample, comprising:
a. at least one optical unit (320) adapted to accommodate said sample; said optical unit comprising a body (10); wherein the internal surface of said body is highly reflected and has mirror-like optical properties; further wherein internal surface is adapted to accommodate said sample:
b. at least one light source (310) adapted to emit light into said optical unit;
c. detecting means, especially spectrometer, (350) adapted to receive the spectroscopic data of said sample by collecting the light exiting from said optical unit; and,
d. processing means (450) in communication with said detecting means, adapted to (i) analyze said spectroscopic data and to (ii) detect the presence of said bacteria within said sample.

93. The optical detection system according to claim 92, wherein said internal surface of said body (10) comprising at least one mirror (50); wherein said mirror (50) having at least one proximal surface and at least one distal surface; wherein said at least one proximal surface is adapted to accommodate said sample.

94. An optical detection system for identifying an infection within a sample, comprising:
a. at least one optical unit (320) adapted to accommodate said sample; said optical unit comprising a body (10); wherein said optical unit is a mirror upon which said sample is placed;
b. at least one light source (310) adapted to emit light into said optical unit;
c. detecting means, especially spectrometer, (350) adapted to receive the spectroscopic data of said sample by collecting the light exiting from said optical unit; and,
d. processing means (450) in communication with said detecting means, adapted to (i) analyze said spectroscopic data and to (ii) detect the presence of said bacteria within said sample.

95. The optical detection system according to claim 92, additionally comprising at least one parabolic mirror in optical communication with said optical unit; and a plurality of adjustable mirrors in optical communication with said at least one parabolic mirror such that said parabolic mirror and said plurality of adjustable mirrors increase the OPL; further wherein said body increases the OPL and decreases the attenuation such that (i) an enhanced light interaction with said sample accommodated within said optical unit is obtained; (ii) the EIL ratio obtained is about 100%; (iii) the minimum no. of bacteria needed for said detection in said optical unit is lower than 0.5 times lower than the minimum No. of bacteria needed for said detection in a standard (conventional) optical unit; the minimum amount C of said bacteria within said sample needed for said detection is lower than 5×10⁵ bacteria.

96. The optical detection system according to claim 92, wherein said body is an elongated tube (10) has an internal lumen; said elongated tube (10) is adapted to accommodate said sample; further wherein internal surface of said body is highly reflected and has mirror-like optical properties.

97. The optical detection system according to claim 92, wherein said optical detection system additionally comprises at least one selected form a group consisting of (a) at least one entrance beam shaping means adapted to shape a light source beam such that the optical light path length is maximized within said body; (b) at least one exit beam shaping means adapted to collect light that is coming out of said body and guiding it to a detector, said exit beams shaping means is selected from a group consisting of lenses and prisms, mirrors, OEM optical element, axicon or any combination thereof; (c) said optical unit additionally comprising at least one check valve (30) at least partially coupled to said distal end of said body (100); adapted to decompress large air volumes entering said elongated tube; or any combination thereof.

98. The optical detection system according to claim 92, wherein at least one of the following is being held true (a) said sample is selected from an aerosol sample, a droplet sample or a swab sample; or any combination thereof; (b) said infection contains bacteria selected from a group consisting of Gram negative pathogens such as Various types of Acinetobacter, A. baumannii, Stenotrophomonas maltophilia, Gram positive pathogens such as Streptococcus pneumonia resistant to b lactamase and macrolides, Streptococcus viridians group resistant to b lactamase and aminoglycosides, enterococci resistant to vancomycin and teicoplanin and highly resistant to penicillins and aminoglycosides, Enterococcus Faecium, Enterococcus Faecalis, staphylococcus aureus SENSITIVE AND resistant to methicillin, other B lactams, macrolides, lincosamides and aminoglicozides. Streptococcus pyogenes resistant to macrolides, macrolide-resistant streptococci of groups B, C and G. Coagulase negative staphylococci resistant to b lactams, aminoglycosides, macrolides, lincosamides and glycopeptides, multiresistant strains of Listeria and corynebacterium, Peptostreptococcus and clostridium, C. Difficile, resistant to penicillins and macrolides, Haemophilus Influenza resistant to b lactamase, Pseudomonas Aeruginosa, Stenotrophomonas Maltophilia, Klebsiella Pneumonia resistant to antibiotics Klebsiella Pneumonia Resistant to carbapenem, Klebsiella Pneumonia sensitive to antibiotics, aminoglycosides and macrolides or any combination thereof; further wherein said detection is made by detecting the absorption spectrum specific for said bacteria.

99. The optical detection system according to claim 92, wherein the internal walls of said body are coated with at least one coating layer, selected from a group consisting of (a) at least one metal layer selected from Au, Ag, Al, Cu etc. or any combination thereof; (b) at least one dielectric layer selected from a group consisting of AgI, CdS, CdSe etc. or any combination thereof; (c) at least one metal layer and one dielectric layer.

100. The optical detection system according to claim 92, wherein at least one of the following is being held true (a) said one optical unit additionally comprising sealing means coupled to said body, and adapted to minimize contamination of said sample; wherein said sealing means comprises a filter; (b) said body additionally comprises an indicator for quantifying said sample; (c) said body is single use and disposable; (d) said optical detection system additionally comprising an RF ID chip utilizing a code such that once said code was read no additional use of said optical unit is enabled.

101. The optical detection system according to claim 92, wherein at least one is being held true (a) said sample is collected from a group consisting of swab, fluid by a capillary tube, humans or animals or non medical material; (b) said detection of said infection is determined from said spectroscopic data in the region of about 3000-3300 cm⁻¹ and/or about 850-1000 cm⁻¹ and/or about 1300-1350 cm⁻¹, and/or about 2836-2995 cm⁻¹, and/or about 1720-1780 cm⁻¹, and/or about 1550-1650 cm⁻¹, and/or about 1235-1363 cm⁻¹, and/or about 990-1190 cm⁻¹ and/or about 1500-1800 cm⁻¹ and/or about 2800-3050 cm⁻¹ and/or about 1180-1290 cm⁻¹.

102. The optical detection system according to claim 92, wherein said optical detection system additionally comprises at least one mirror, adapted to reflect a light source beam such that a maximal area of said proximal surface is hit by said light, for at least one period of time; further wherein said optical detection system additionally comprises at least one lens, adapted to refract a light source beam such that a maximal area of said proximal surface is hit by said light, for at least one time; further wherein said light source (310) is adapted to emit un-collimated light into said optical unit; further wherein said un-collimated light has an angle of diverse of at least 25 milli-radians.

103. A method for optically detecting or identifying an infection within a sample, said method comprising steps of:
a. obtaining at least one optical unit (320) adapted to accommodate said infection; said optical unit comprising a body (10); wherein the internal surface of said body is highly reflected and has mirror-like optical properties; further wherein internal surface is adapted to accommodate said sample:
b. accommodating within said optical unit said sample;
c. coupling at least one light source (310) to said optical unit;
d. coupling detecting means, especially spectrometer, (350) to said optical unit;
e. providing processing means (450) in communication with said detecting means, adapted to (i) analyze said spectroscopic data and to (ii) detect the presence of said bacteria within said sample;
f. emitting light from said light source (310) into said optical unit (320);
g. collecting the light exiting from said optical unit by said detecting means;
h. detecting and processing said light emitted from said optical unit (320) by said detecting means and said processing means; and,
i. identifying said infection.

104. A method for optically detecting or identifying an infection within a sample, said method comprising steps of:
a. obtaining at least one optical unit (320) adapted to accommodate said infection; said optical unit comprising a body (10); wherein said optical unit is a mirror upon which said sample is placed;
b. accommodating upon said optical unit said sample;
c. coupling at least one light source (310) to said optical unit;
d. coupling detecting means, especially spectrometer, (350) to said optical unit;
e. providing processing means (450) in communication with said detecting means, adapted to (i) analyze said spectroscopic data and to (ii) detect the presence of said bacteria within said sample;
f. emitting light from said light source (310) into said optical unit (320);
g. collecting the light exiting from said optical unit by said detecting means;
h. detecting and processing said light emitted from said optical unit (320) by said detecting means and said processing means; and,
i. identifying said infection;
wherein said step of accommodating upon said optical unit said sample is performed by smearing said sample upon said mirror.
